(19) United States
(12) Patent Application Publication
(10) Pub. No.: US 2017/0043197 A1
(43) Pub. Date: Feb. 16, 2017

(54) Block Copolymer Complex Coacervate Core Micelles for Enzymatic Catalysis in Organic Solvent

(71) Applicant: Massachusetts Institute of Technology, Cambridge, MA (US)

(72) Inventors: Bradley D. Olsen, Arlington, MA (US); Carolyn E. Mills, Cambridge, MA (US); Xuehui Dong, Cambridge, MA (US); Allie C. Obermeyer, Cambridge, MA (US)

(21) Appl. No.: 14/855,828

(22) Filed: Sep. 16, 2015

Related U.S. Application Data
(60) Provisional application No. 62/050,823, filed on Sep. 16, 2014.

(51) Int. Cl. A62D 3/02; C11D 3/37; C11D 3/386

(52) U.S. Cl. CPC A62D 3/02; C12Y 301/08001; C11D 3/386; C11D 3/378; A62D 2101/26

(57) ABSTRACT

Disclosed are complex coacervate core micelles comprising an enzyme capable of hydrolyzing organophosphorus compounds, such as nerve agents, and, for example, their use in remediation or decontamination of stockpiles of chemical weapons.

### RELATED APPLICATIONS

This application claims the benefit of priority to U.S. Provisional Patent Application Ser. No. 62/050,823, filed Sep. 16, 2014; the contents of which are hereby incorporated by reference.

### GOVERNMENT SUPPORT

This invention was made with Government support under Contract No. HR0011-14-C-0030 awarded by the Defense Advanced Research Projects Agency. The government has certain rights in the invention.

### BACKGROUND

Enzymes or enzyme clusters can be isolated in a variety of nanostructures, such as viral capsids, reverse micelles, and polymersomes. Studying such encapsulated enzymes has shed light on enzymatic behavior in the absence of bulk aqueous solution. Nanostructures may also be used to solubilize directly and efficiently protein clusters into organic solvents containing small quantities of surfactant and trace amounts of water. As a result of this stabilization, enzymes may also exhibit increased enzyme activity relative to extracted enzyme activity. This approach is appealing for bioreactor fabrication; of particular interest is the fabrication of bioreactors capable of efficiently and effectively sequestering and eliminating dangerous chemicals, such as nerve agents. However, there are critical issues regarding the regulation of solute transport through membranes of the nanostructure, enzyme loading without denaturation, and physiological stability.

Thus, there is an unmet need for bioreactors capable of efficiently and effectively sequestering and eliminating dangerous chemicals, such as nerve agents.

### SUMMARY

In certain embodiments, the invention relates to a nanostructure, comprising, consisting essentially of, or consisting of:
(i) a polyanionic polymer;
   a block copolymer; and
   an enzyme; or
(ii) a block copolymer; and
   a modified enzyme.

In certain embodiments, the invention relates to any one of the nanostructures described herein, wherein the block copolymer comprises a plurality of first repeat units, and a plurality of second repeat units;

the first repeat unit is

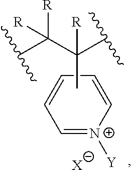

wherein, independently for each occurrence,
R is H, alkyl, halo, hydroxy, amino, nitro, or cyano;
Y is alkyl; and
X⊖ is an anion; and

the second repeat unit is

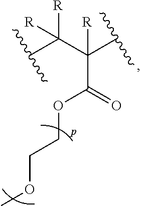

wherein, independently for each occurrence,
R is H, alkyl, halo, hydroxy, amino, nitro, or cyano; and
p is 2-20, inclusive.

In certain embodiments, the invention relates to any one of the nanostructures described herein, wherein the enzyme or modified enzyme is an organophosphate hydrolase or a modified organophosphate hydrolase.

In certain embodiments, the invention relates to any one of the nanostructures described herein, wherein the enzyme or modified enzyme is an organophosphate acid anhydrolase or a modified organophosphate acid anhydrolase.

In certain embodiments, the invention relates to a composition, comprising, consisting essentially of, or consisting of:

an organic phase, an aqueous liquid phase, and a plurality of any of the nanostructures described herein.

In certain embodiments, the invention relates to a method of hydrolyzing an organophosphorous compound, comprising contacting the organophosphorous compound with an effective amount of any of the nanostructures or compositions described herein.

In certain embodiments, the invention relates to a method of decontaminating an area or a device contaminated with an organophosphorous compound, comprising contacting the area or the device with an effective amount of any of the nanostructures or compositions described herein.

### BRIEF DESCRIPTION OF THE FIGURES

FIG. 1A depicts the hydrolysis of sarin by organophosphate hydrolase (OPH).

FIG. 1B depicts the hydrolysis of VX by organophosphate acid anhydrolase (OPAA).

FIG. 2 is a schematic representation of a complex coacervate core micelle acting as a nanoreactor.

FIG. 3 depicts an exemplary synthesis of POEGMA-b-quaternized P4VP.

FIG. 4 is a schematic representation of a general method of forming complex coacervate core micelles (C3Ms) with a block copolymer, such as POEGMA-b-qP4VP, and a protein, such as organophosphate hydrolase.

FIG. 5 is a schematic representation of a general method of forming C3Ms with a block copolymer and a supercharged protein.

FIG. 6A depicts a method of supercharging a protein comprising a lysine residue.

FIG. 6B depicts the zeta potential of supercharged proteins as compared to unmodified proteins.

FIG. 7A depicts two components, a supercharged protein and a quaternized P4VP homopolymer, used to investigate coacervation.

FIG. 7B depicts the results of dynamic light scattering (DLS) studies at 600 nm of the components from FIG. 7A in 50 mM phosphate buffer at pH 7.0, 8.0, and 9.0, as a function of weight fraction qP4VP.

FIG. 8 has three panels showing mass spectra of chymotrypsinogen, either unmodified (left panel), or modified by succinic anhydride via the method depicted in FIG. 6A (middle panel=10 equiv. succinic acid; right panel=20 equiv. succinic acid).

FIG. 9 depicts the results of DLS studies at 600 nm of the components from FIG. 7A in 50 mM phosphate buffer at pH 8.0, as a function of weight fraction qP4VP. The 0.5 weight fraction was selected for DLS studies with the block copolymer.

FIG. 10A depicts two components, a supercharged protein and a POEGMA-b-qP4VP block copolymer, used to investigate micelle formation.

FIG. 10B has two panels showing the results of DLS studies of the components from FIG. 10A in 50 mM phosphate buffer at pH 8.0, ethanol, or DMMP (left panel=hydrodynamic radius, right panel=% mass breakdown by hydrodynamic radius). The data show that micelles are formed in DMMP, however, large aggregates are also formed.

FIG. 11 is a schematic representation of a general method for forming C3Ms with a block copolymer, a protein, and a charged homopolymer.

FIG. 12A depicts two components, a charged homopolymer and a quaternized P4VP homopolymer, used to investigate coacervation.

FIG. 12B depicts the results of DLS studies at 600 nm of the components from FIG. 12A in 50 mM phosphate buffer at pH 7.0, 8.0, and 9.0, as a function of weight fraction qP4VP.

FIG. 13A depicts three components (i.e., a charged homopolymer, a quaternized P4VP homopolymer, and a protein) used to investigate coacervation.

FIG. 13B depicts the results of DLS studies at 600 nm of the components from FIG. 13A in 50 mM phosphate buffer at pH 7.0, 8.0, and 9.0, as a function of weight fraction qP4VP. The 0.7 weight fraction was selected for DLS studies shown in FIG. 14A and FIG. 14B. The 0.2 weight fraction was selected for DLS studies shown in FIG. 15.

FIG. 14A depicts three components (i.e., a charged homopolymer, a POEGMA-b-qP4VP block copolymer, and a protein) used to investigate micelle formation.

FIG. 14B has two panels (left=amylase, right=chymotrypsinogen) depicting % mass breakdown by hydrodynamic radius of the micelles formed by the components from FIG. 14A.

FIG. 15 has two panels (left=amylase, right=chymotrypsinogen) depicting % mass breakdown by hydrodynamic radius of the micelles formed by the components from FIG. 14A.

FIG. 16 depicts turbidimetry data showing that no bulk coacervation occurs between α-chymotrypsinogen and qP4VP (squares), indicated by a near 100% transmittance at all mixing ratios, and that bulk coacervation occurs across a wide range of charge fractions (f⁺=0.3-0.8) between PAA and qP4VP (circles), indicated by a significant decrease in transmittance between these charge fractions.

FIG. 17A depicts DLS data of coacervate core micelle solutions (POEGMA-b-qP4VP mixed with PAA) at f⁺=0.3 that shows the percent mass of small scatterers (squares, likely complexes or free polymer), micelle-sized species (circles), and larger species (triangles, likely dust or aggregates) as a function of HEPES concentration, showing that the micelles are stable to conditions up to 50 mM HEPES.

FIG. 17B depicts DLS data of coacervate core micelle solutions (POEGMA-b-qP4VP mixed with PAA) at f⁺=0.3 that shows the percent intensity of small scatterers (squares, likely complexes or free polymer), micelle-sized species (circles), and larger species (triangles, likely dust or aggregates) as a function of HEPES concentration, showing that the micelles are stable to conditions up to 50 mM HEPES.

FIG. 18A depicts DLS data of coacervate core micelle solutions (POEGMA-b-qP4VP mixed with PAA) in 50 mM pH 8 HEPES buffer that shows the percent mass of small scatterers (squares), likely complexes or free polymer), micelle-sized species (circles), and larger species (triangles, likely dust or aggregates) as a function of positive charge fraction, showing that the positive charge fraction f⁺=0.2-0.4 gives reliable conditions for micelle formation.

FIG. 18B depicts DLS data of coacervate core micelle solutions (POEGMA-b-qP4VP mixed with PAA) in 50 mM pH 8 HEPES buffer that shows the percent intensity of small scatterers (squares), likely complexes or free polymer), micelle-sized species (circles), and larger species (triangles, likely dust or aggregates) as a function of positive charge fraction, showing that the positive charge fraction f⁺=0.2-0.4 gives reliable conditions for micelle formation.

FIG. 19 depicts small angle neutron scattering (SANS) of micelles with OPH protein in 50 mM pH 8 HEPES at f⁺=0.3, total polymer concentration 20 mg/mL, OPH concentration at ˜2 mg/mL. A fuzzy spheres fit gives a mean radius of 15.1 nm, and an interface thickness of 2.9 nm.

FIG. 20 depicts the specific activities against paraoxon of OPH only, OPH with PAA, OPH with POEGMA-b-qP4VP, and OPH in micelles. This shows that OPH with the block copolymer and in the micelles retains its activity over time after treatment at 37° C. in 50 mM pH 8 HEPES buffer.

FIG. 21A depicts DLS data showing percent mass of different species—Small scatterers (squares, free polymer or small micelles), micelle-sized species (circles), larger scatterers (point-down triangles, possibly cylindrical micelles), and large aggregates (point-up triangles)—as a function of HEPES concentration. There is little dependence of inverse micelle formation on salt concentration. Conditions: 4 mg/mL POEGMA-b-qP4VP in 4% HEPES buffer, 96% ethanol.

FIG. 21B depicts DLS data showing percent intensity of different species—Small scatterers (squares, free polymer or small micelles), micelle-sized species (circles), larger scatterers (point-down triangles, possibly cylindrical micelles), and large aggregates (point-up triangles)—as a function of HEPES concentration. There is little dependence of inverse micelle formation on salt concentration. Conditions: 4 mg/mL POEGMA-b-qP4VP in 4% HEPES buffer, 96% ethanol.

FIG. 22A depicts DLS data showing percent mass of different species—Small scatterers (squares, free polymer or small micelles), micelle-sized species (circles), larger scatterers (point-down triangles, possibly cylindrical micelles), and large aggregates (point-up triangles)—as a function of HEPES concentration. There is little dependence of inverse micelle formation on salt concentration. Conditions: 4 mg/mL POEGMA-b-qP4VP in 4% HEPES buffer, 96% DMMP.

FIG. 22B depicts DLS data showing percent intensity of different species—Small scatterers (squares, free polymer or small micelles), micelle-sized species (circles), larger scatterers (point-down triangles, possibly cylindrical micelles), and large aggregates (point-up triangles)—as a function of HEPES concentration. There is little dependence of inverse micelle formation on salt concentration. Conditions: 4 mg/mL POEGMA-b-qP4VP in 4% HEPES buffer, 96% DMMP.

FIG. 23A depicts DLS data showing percent mass of different species—Small scatterers (squares, free polymer or small micelles), micelle-sized species (circles), larger scatterers (point-down triangles, possibly cylindrical micelles), and large aggregates (point-up triangles)—as a function of positive charge fraction. Mostly precipitates form when the solution is made up of mostly PAA (due to its insolubility in organic solvents), that changes into a solution that is mostly micelles (˜30 nm in radius) between f⁺=0.2-0.6, and then into a mixture of micelles (˜30 nm in radius) and larger structures (˜200 nm in radius). Conditions: 4 mg/mL total POEGMA-b-qP4VP and PAA concentration in 4% 50 mM pH 8HEPES buffer, 96% ethanol.

FIG. 23B depicts DLS data showing percent intensity of different species—Small scatterers (squares, free polymer or small micelles), micelle-sized species (circles), larger scatterers (point-down triangles, possibly cylindrical micelles), and large aggregates (point-up triangles)—as a function of positive charge fraction. Mostly precipitates form when the solution is made up of mostly PAA (due to its insolubility in organic solvents), that changes into a solution that is mostly micelles (˜30 nm in radius) between f⁺=0.2-0.6, and then into a mixture of micelles (˜30 nm in radius) and larger structures (˜200 nm in radius). Conditions: 4 mg/mL total POEGMA-b-qP4VP and PAA concentration in 4% 50 mM pH 8HEPES buffer, 96% ethanol.

FIG. 24A depicts DLS data showing percent mass of different species—Small scatterers (squares, free polymer or small micelles), micelle-sized species (circles), larger scatterers (point-down triangles, possibly cylindrical micelles), and large aggregates (point-up triangles)—as a function of positive charge fraction. Mostly precipitates form when the solution is made up of mostly PAA (due to its insolubility in organic solvents), that changes into a solution that is mostly micelles (˜30 nm in radius) between f⁺=0.3-0.5, back into large aggregates at higher charge fractions, and final into smaller inverse micelles at f⁺=1.0. Conditions: 4 mg/mL total POEGMA-b-qP4VP and PAA concentration in 4% 50 mM pH 8 HEPES buffer, 96% DMMP.

FIG. 24B depicts DLS data showing percent intensity of different species—Small scatterers (squares, free polymer or small micelles), micelle-sized species (circles), larger scatterers (point-down triangles, possibly cylindrical micelles), and large aggregates (point-up triangles)—as a function of positive charge fraction. Mostly precipitates form when the solution is made up of mostly PAA (due to its insolubility in organic solvents), that changes into a solution that is mostly micelles (˜30 nm in radius) between f⁺=0.3-0.5, back into large aggregates at higher charge fractions, and final into smaller inverse micelles at f⁺=1.0. Conditions: 4 mg/mL total POEGMA-b-qP4VP and PAA concentration in 4% 50 mM pH 8 HEPES buffer, 96% DMMP.

FIG. 25 depicts the specific activity against paraoxon of OPH in 90% 50 mM pH 8 HEPES after treatment for 24 hours in 96% ethanol (left bar) and DMMP (right bar). These data shows that the block copolymer is able to stabilize against treatment with ethanol, but not DMMP. The micelles are able to stabilize against DMMP, which is a good simulant for organophosphate compounds.

FIG. 26 has five panels (a-e) showing the supercharging of model proteins. (a) Model proteins selected, represented with electrostatic surface potential (±5 kT/e_{c}) at the solvent-accessible surface rendered from solutions of the linearized Poisson-Boltzmann equation using the Adaptive Poisson-Boltzmann Solver (APBS). (b) Schematic for the chemical supercharging of model proteins with succinic anhydride. (c) Representative, deconvoluted ESI LC-MS of lysozyme treated with variying equivalents of succinic anhydride. (d) Average number of modifications on the four model proteins after treatment with varying equivalents of succinic anhydride shown with the variance in the number of modifications. (e) Expected protein charge for the supercharged model proteins.

FIG. 27A depicts a summary of the turbidity profiles as a funciton of charge fraction (for negatively charged proteins, circles) or polymer weight fraction (for positively charged proteins, triangles) in 10 mM tris buffer, pH 8.0 (α-Chymotrypsinogen (upper left), lysozyme (upper right), myoglobin (bottom left), RNase A (bottom right)).

FIG. 27B depicts bright field optical micrographs showing the lack of phase separation, liquid coacervates, or solid precipitates resulting from mixing supercharged proteins with qPDMAEMA at the midpoint of bulk coacervation. Scale bars, 20 μm.

FIG. 28 has two panels (a and b) showing salt and pH titrations of RNase A coacervates. (a) Turbidimetric pH titrations of RNase A with qP4VP at an ionic strength of 10 mM and protein-polymer ratio r=5. (b) Effects of supercharging on RNaseA-qP4VP coacervate dissolution by added NaCl. Measurements were performed at r=24 (RNase A—2.6), r=6.1 (RNase A—11.5), r=4 (RNase A—13.9), and r=3.2 (RNase A—14.8) in 10 mM tris buffer, pH 8.0.

FIG. 29 has two panels (a and b) showing protein incorporation in the coacervate phase. (a) Protein partitioning in the coacervate phase as a function of the expected protein charge. (b) Incorporation of supercharged proteins in the coacervate phase as a function of the protein-to-polymer ratio.

FIG. 30A has four panels (top left, top right, bottom left, and bottom right) depicting the percentage of micelles in solution as determined by DLS intensity plotted as a funciton of charge fraction for chymotrypsinogen (top left), lysozyme (top right), myoglobin (bottom left), and RNase A (bottom right).

FIG. 30B has four panels (top left, top right, bottom left, and bottom right) depicting the average micelle radii plotted as a function of charge fraction for chymotrypsinogen (top left), lysozyme (top right), myoglobin (bottom left), and RNase A (bottom right).

FIG. 31 has three panels (a-c) showing the stability of the complex coacervate core micelles. (a) Thermal stability of the micelles was assayed by DLS. The percentage of micelles in solution (left) and average hydrodynamic radius (right) are plotten as a funciton of temperature. (b) The ability of the micelles to reform after lyophilization was confirmed by DLS measurements before and after lyophilizing RNase A C3Ms. (c) Stability of micelles with RNase A to increased ionic strength was investigated by DLS and the average Rₕ is plotted as a function of NaCl concentration.

### DETAILED DESCRIPTION

### Overview

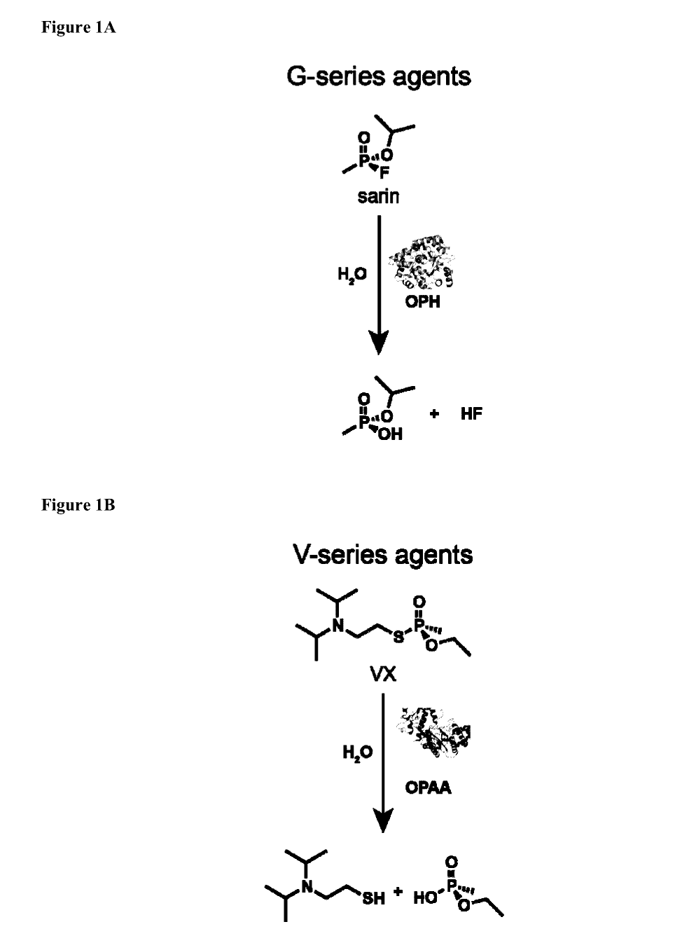

In certain embodiments, the invention relates to compositions and methods for catalyzing the hydrolysis of organophosphates, such as G-series or V-series nerve agents. See FIG. 1A and FIG. 1B. In certain embodiments, the invention relates to a method of remediating bulk chemical warfare agents, for example, on-site remediation.

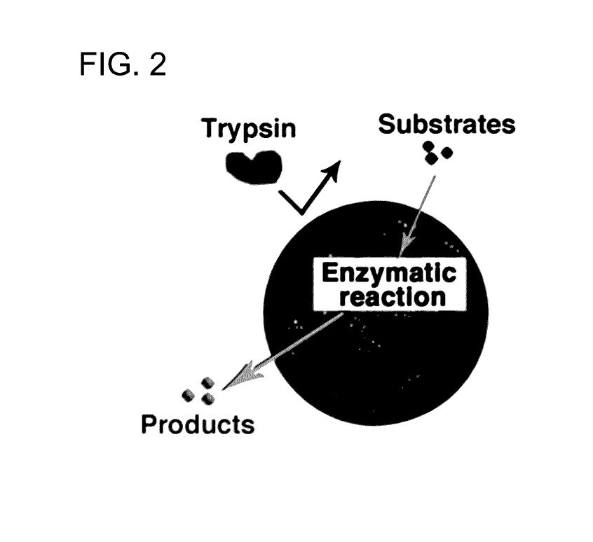

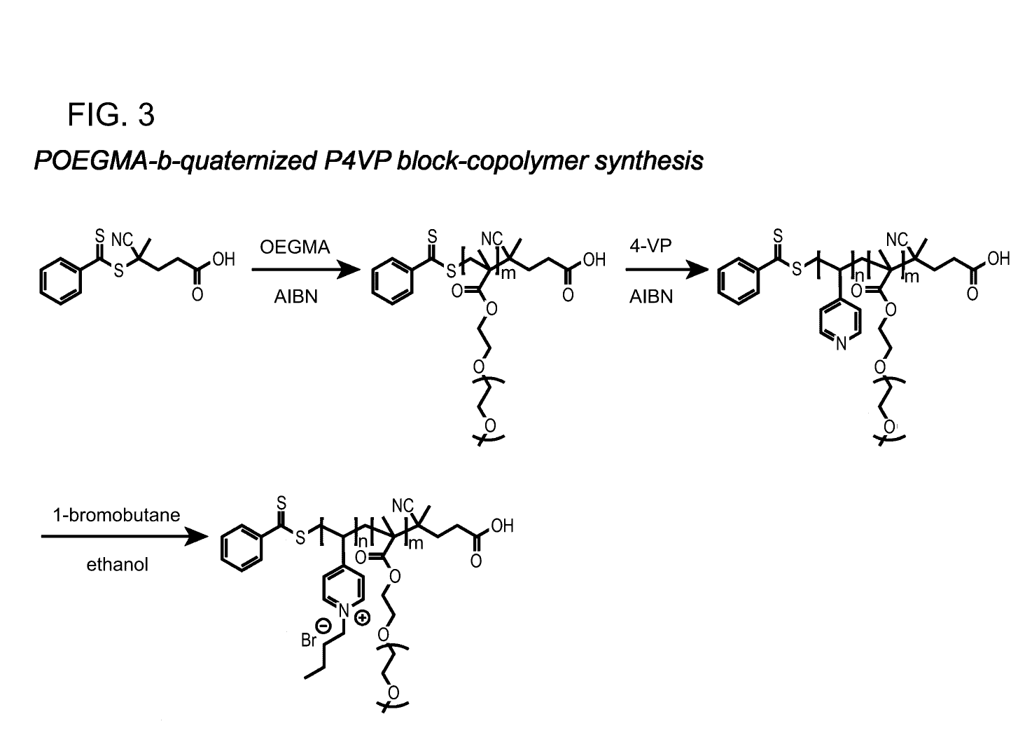

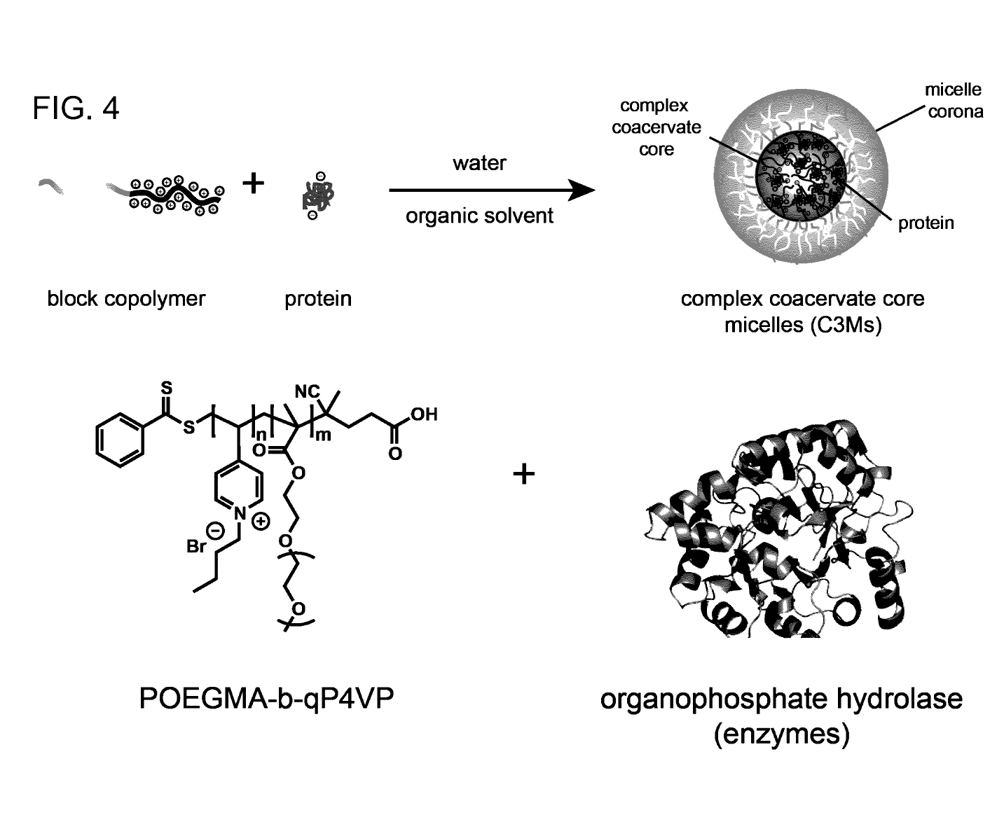

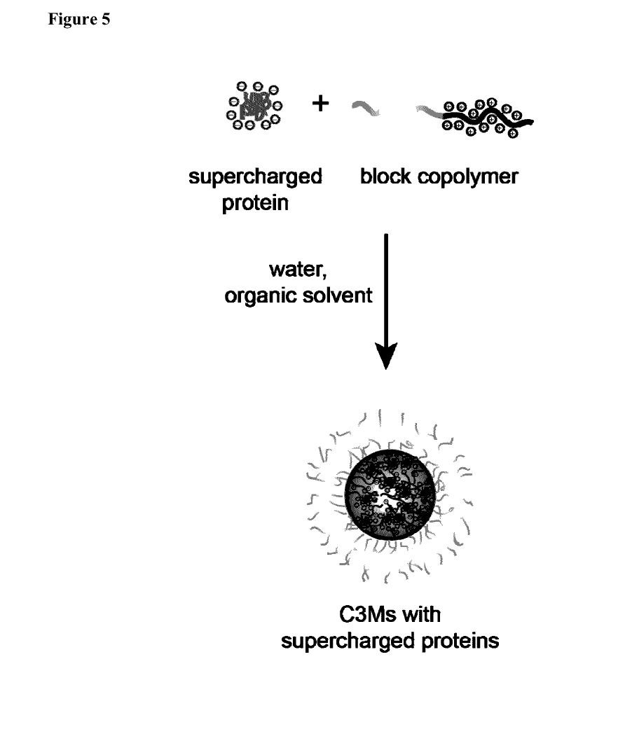

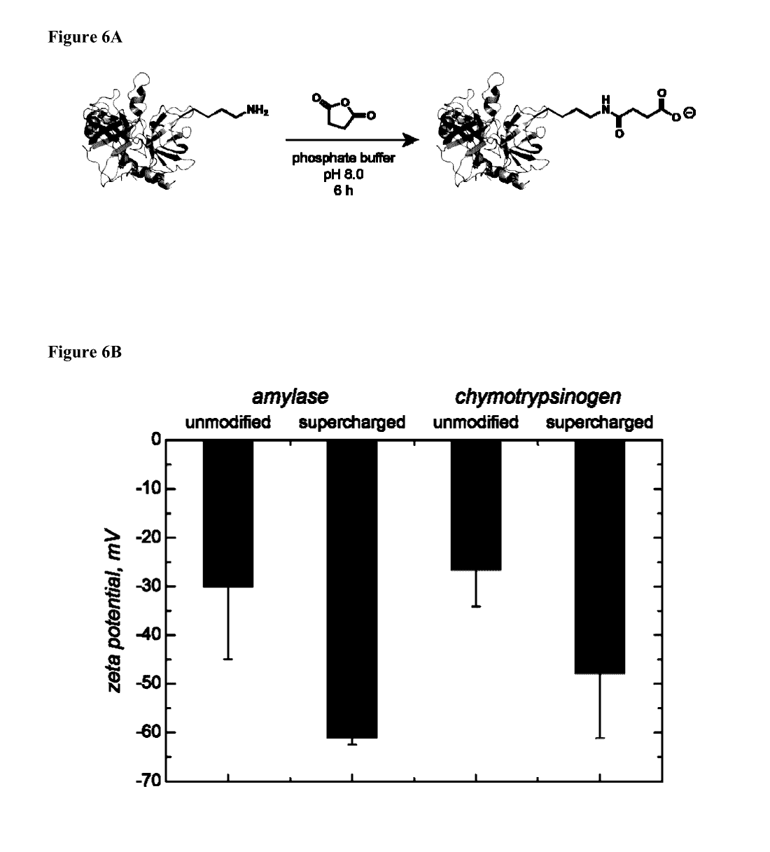

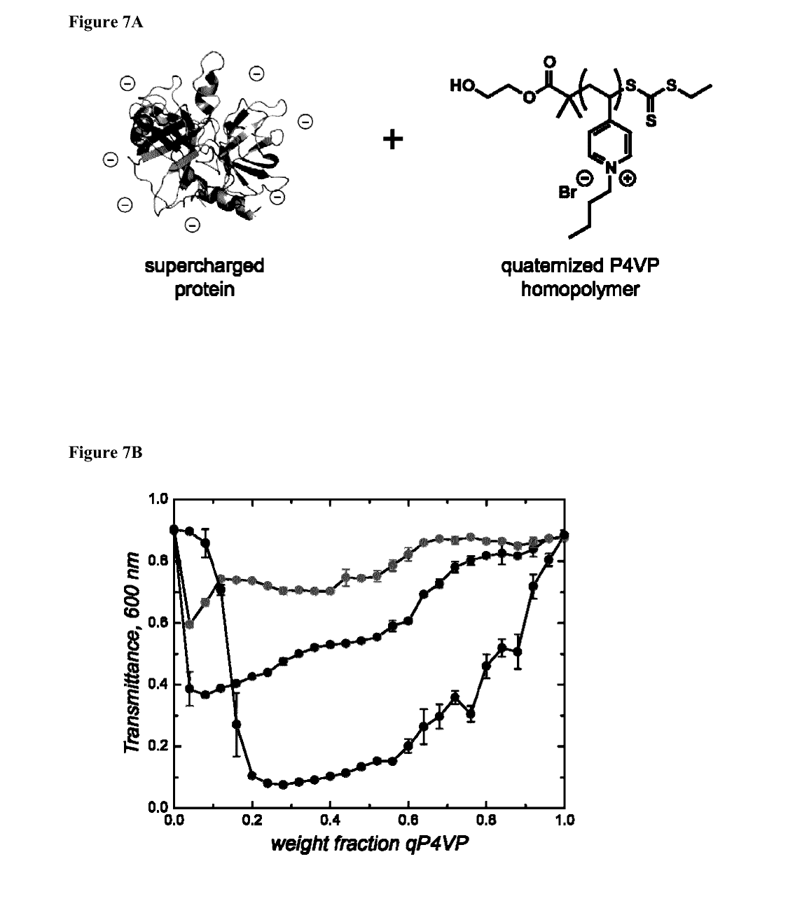

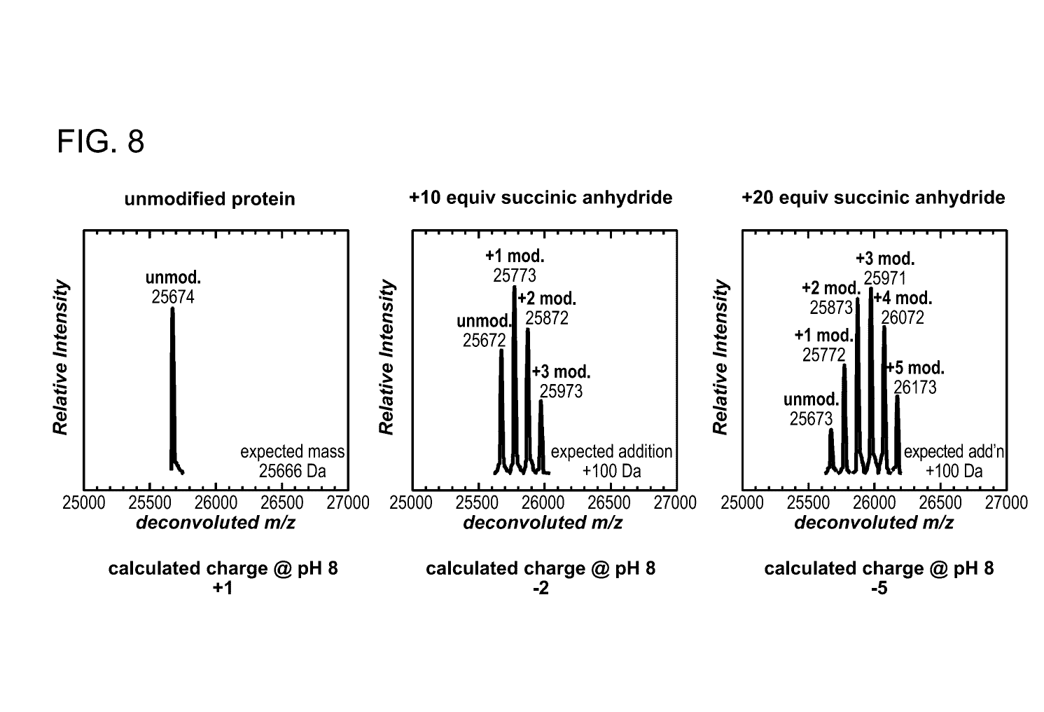

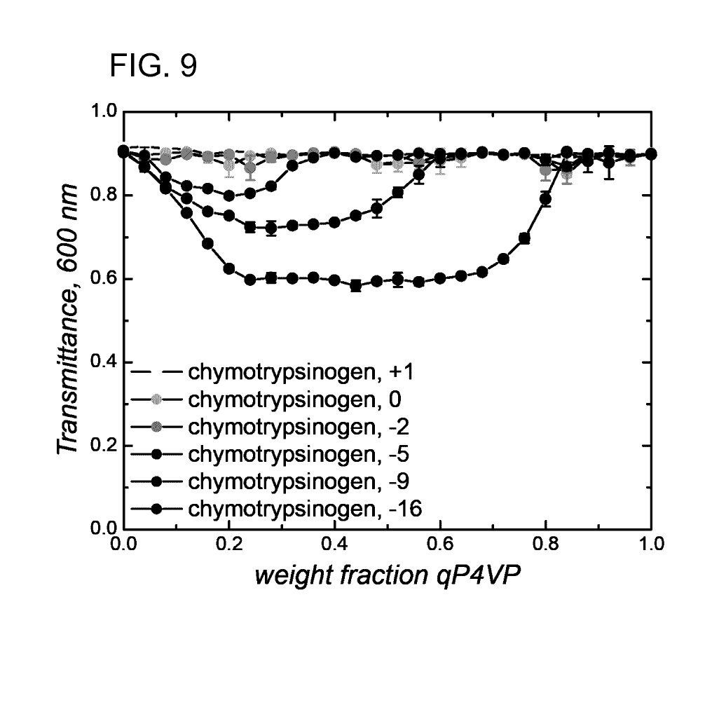

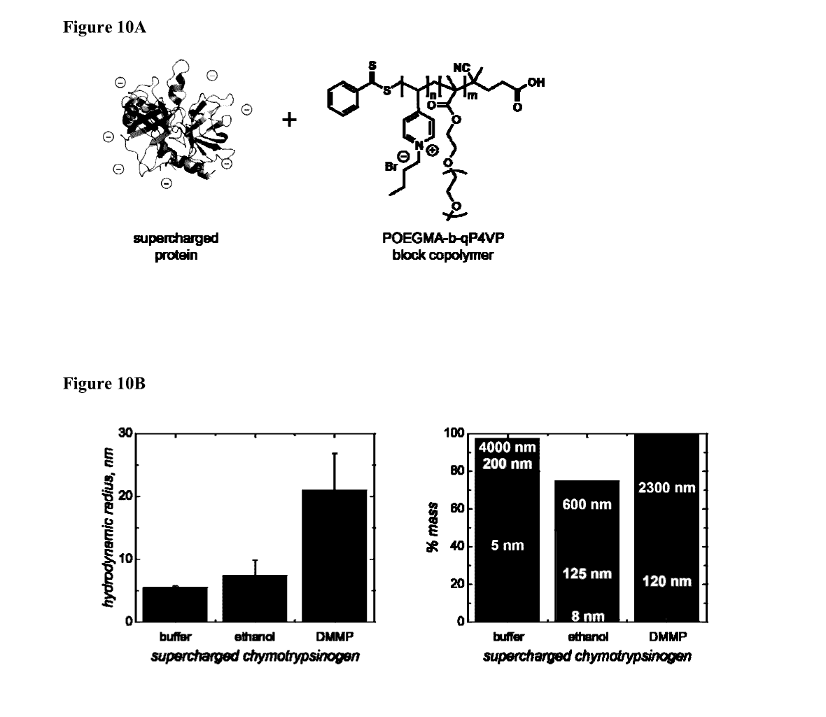

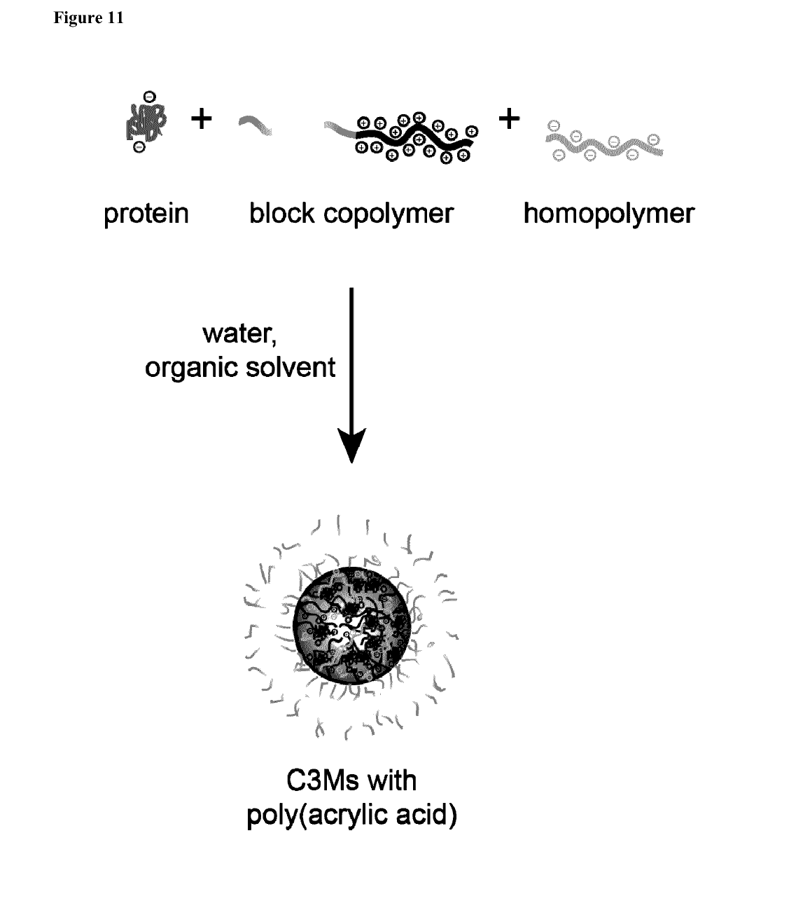

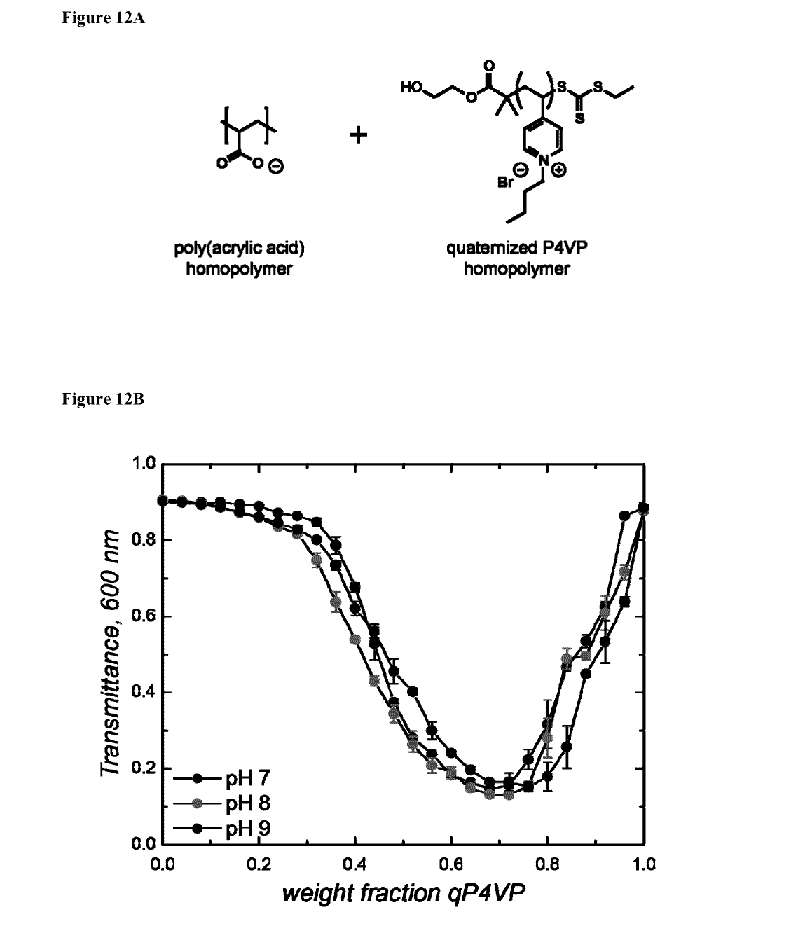

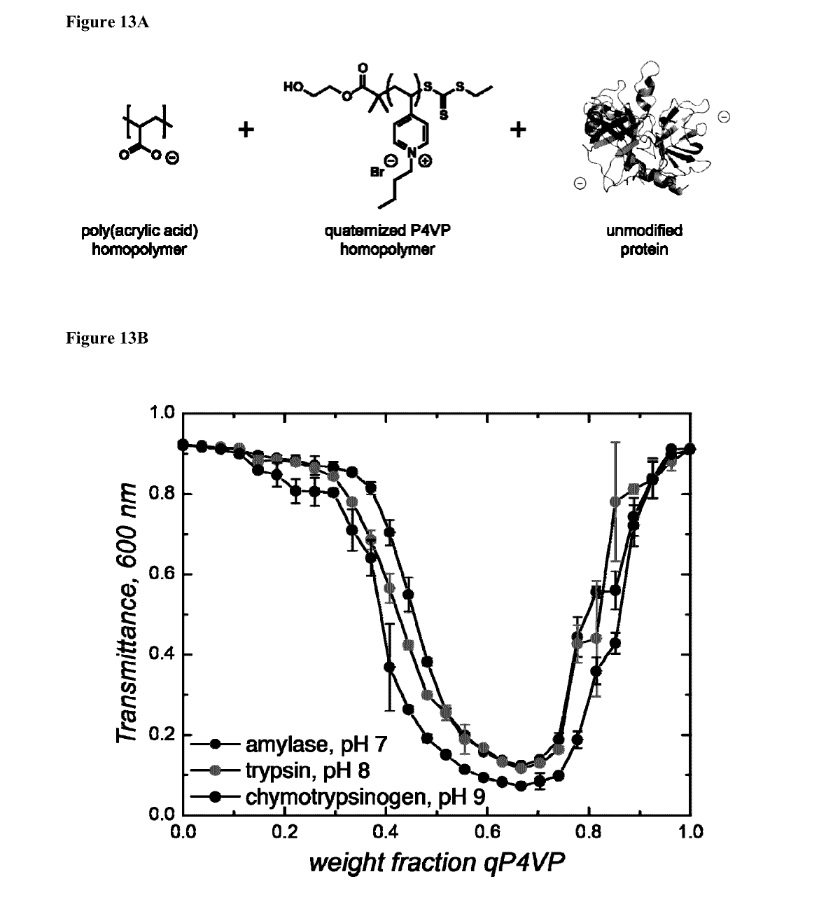

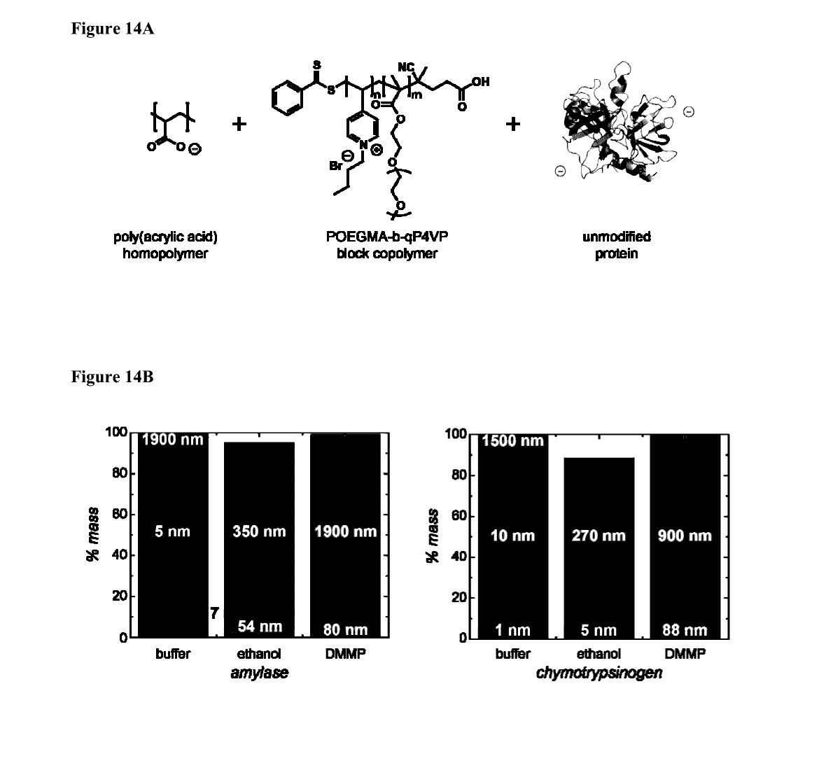

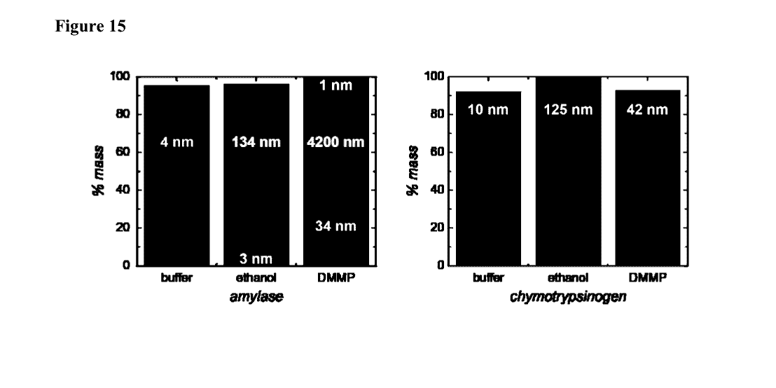

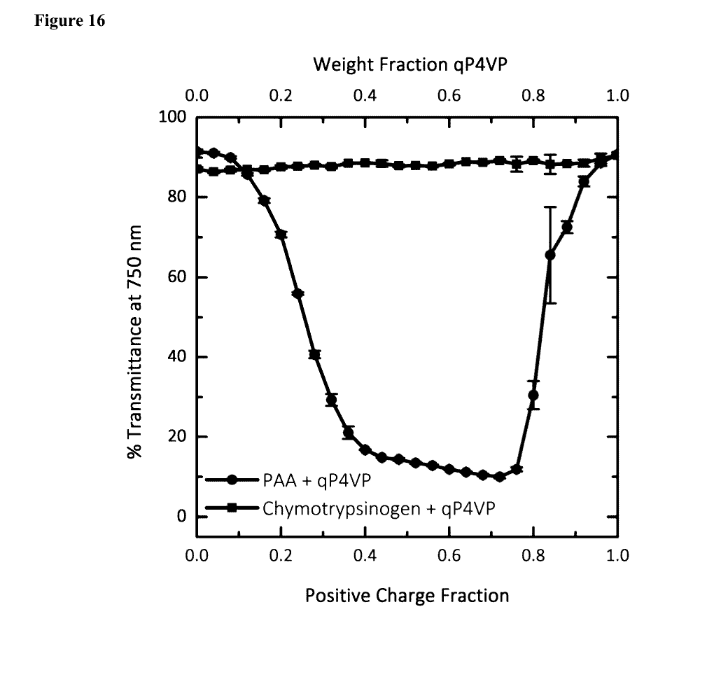

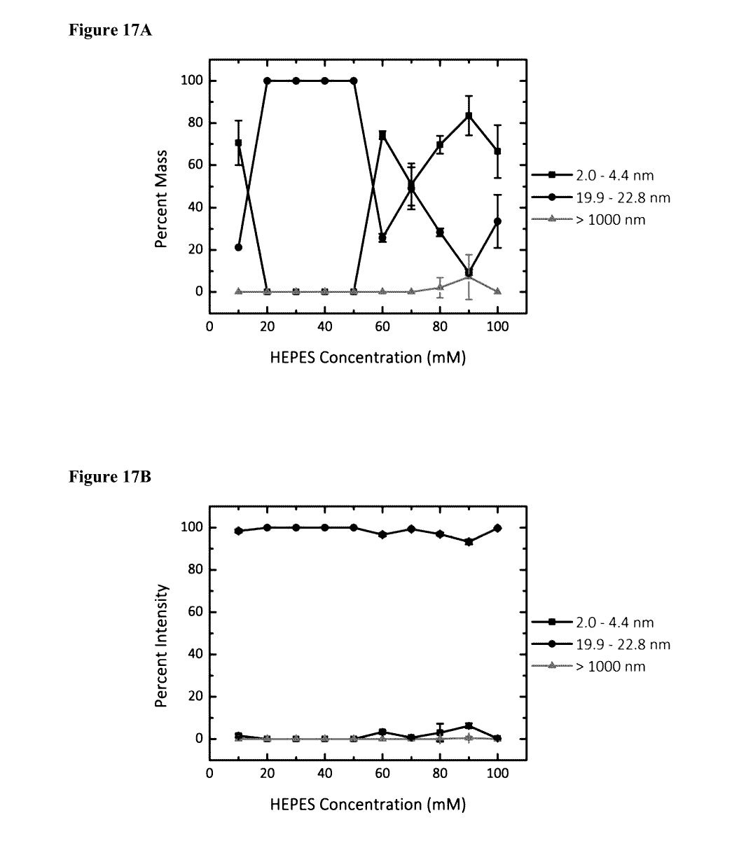

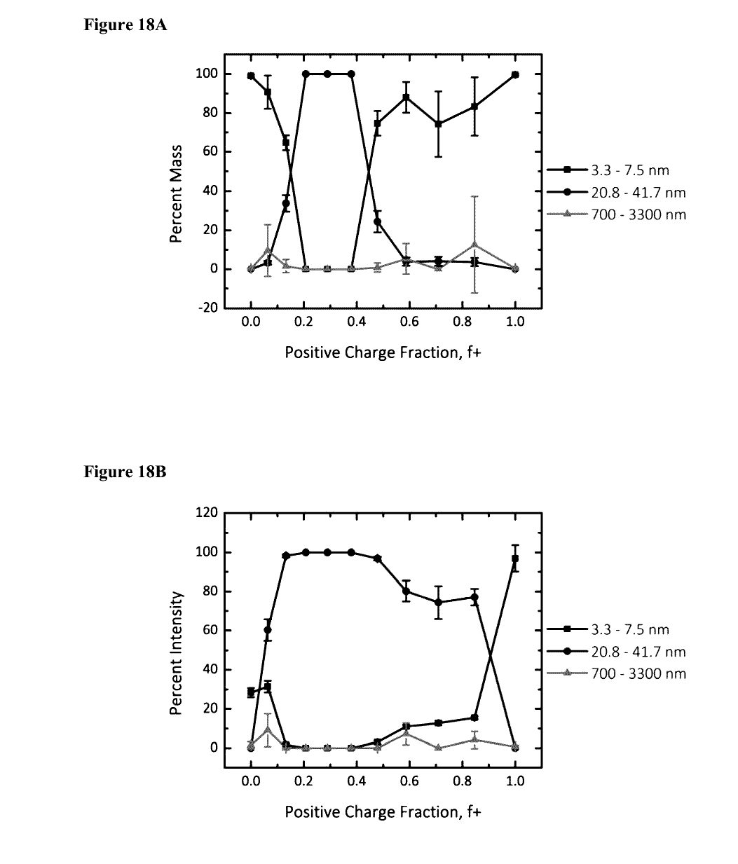

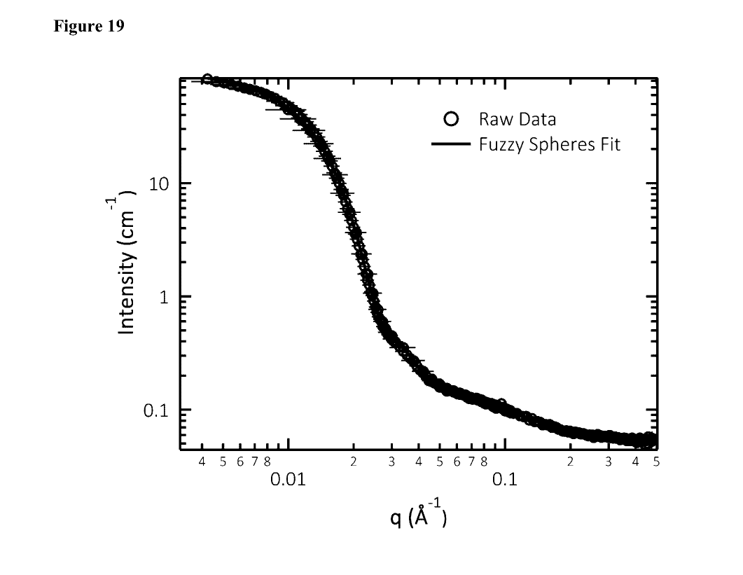

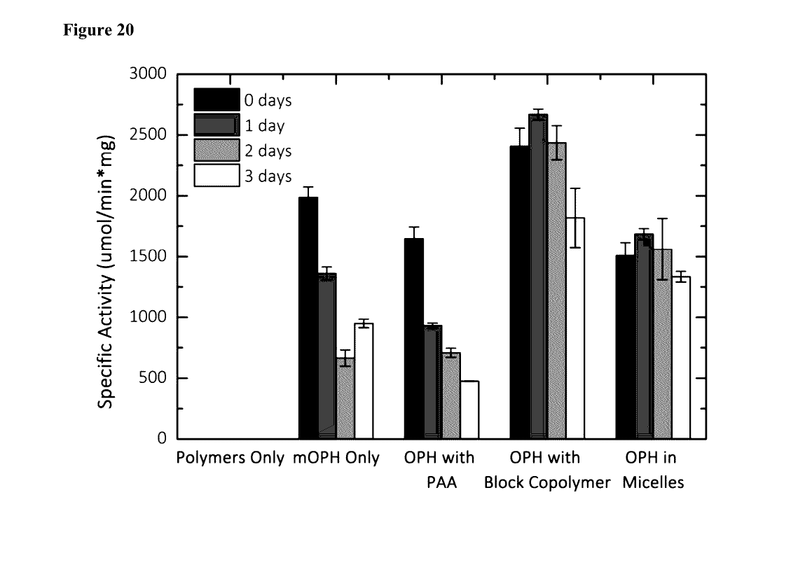

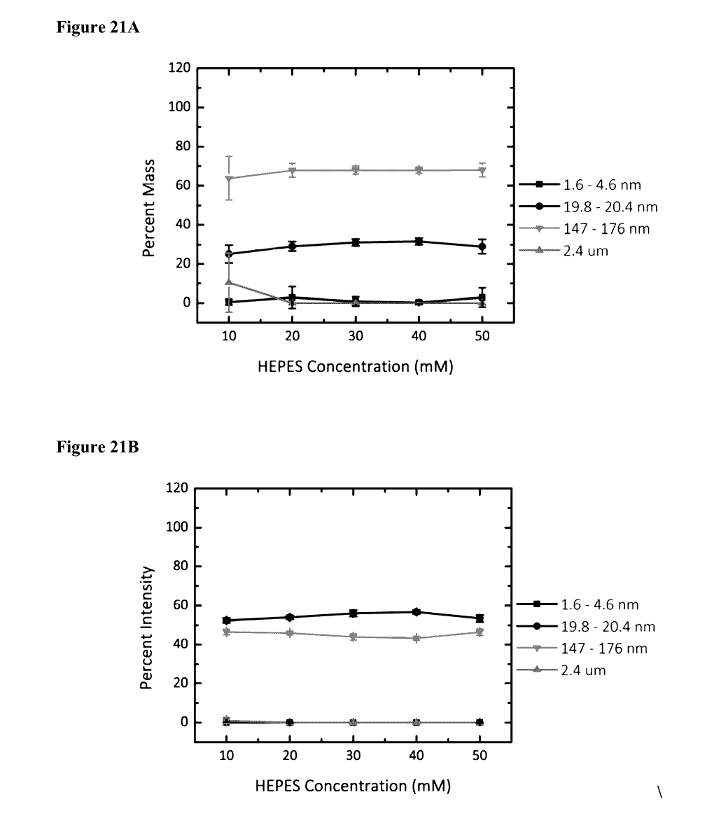

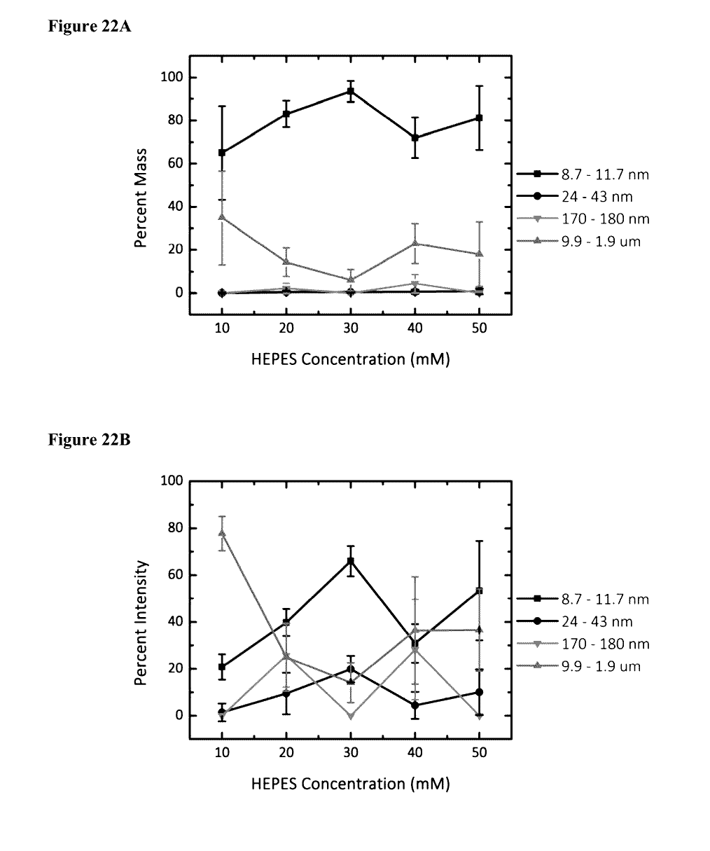

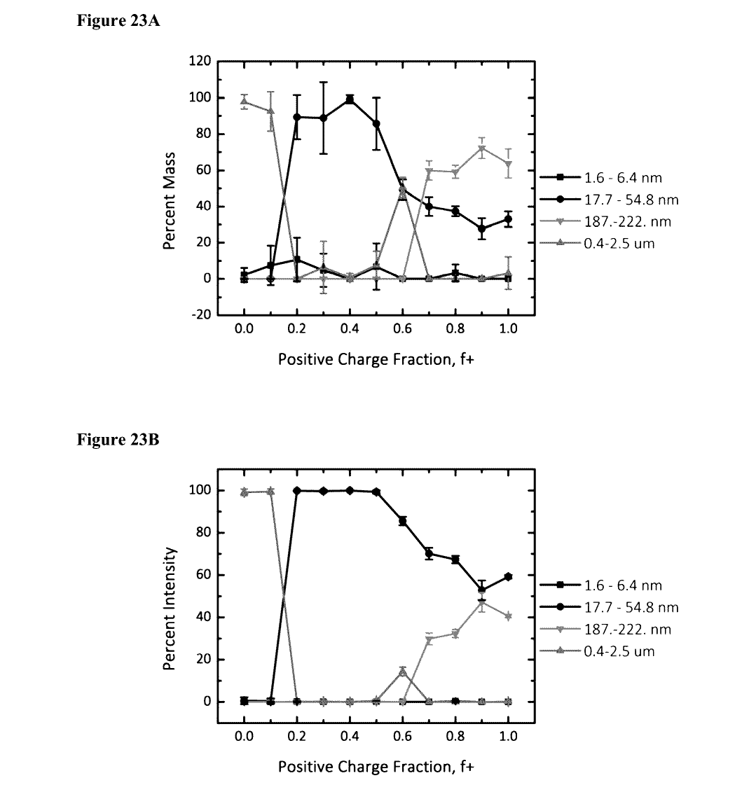

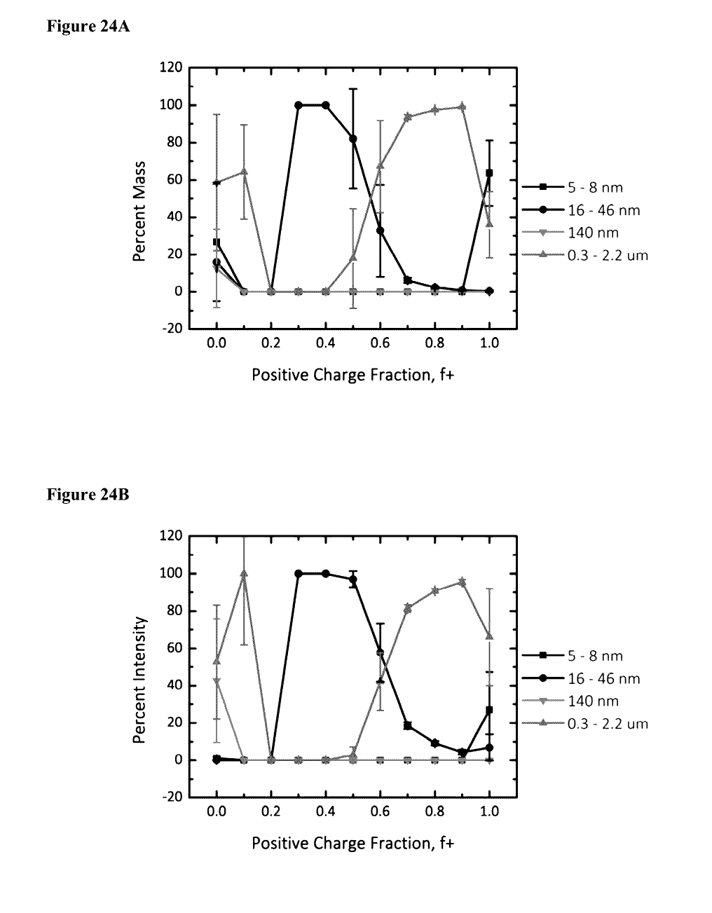

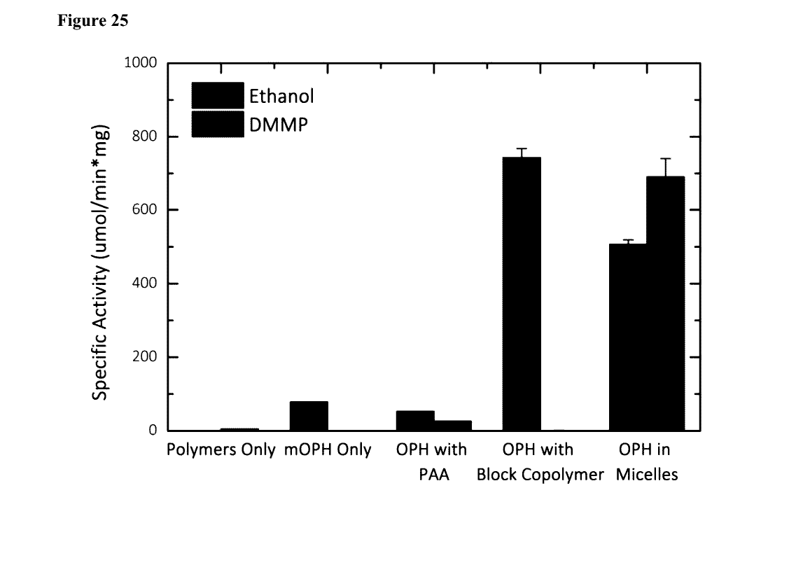

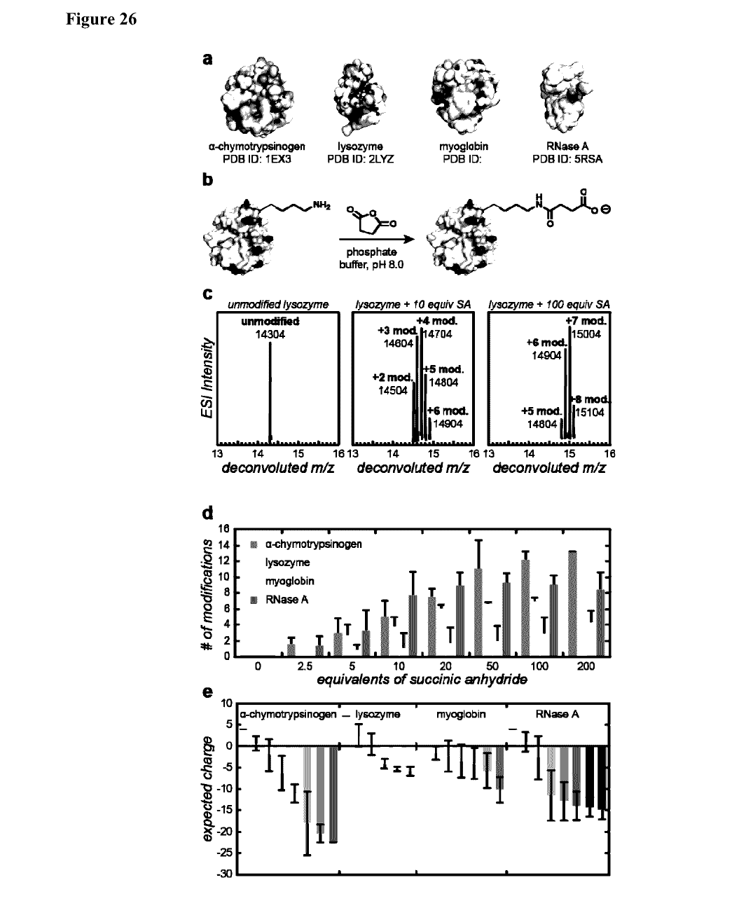

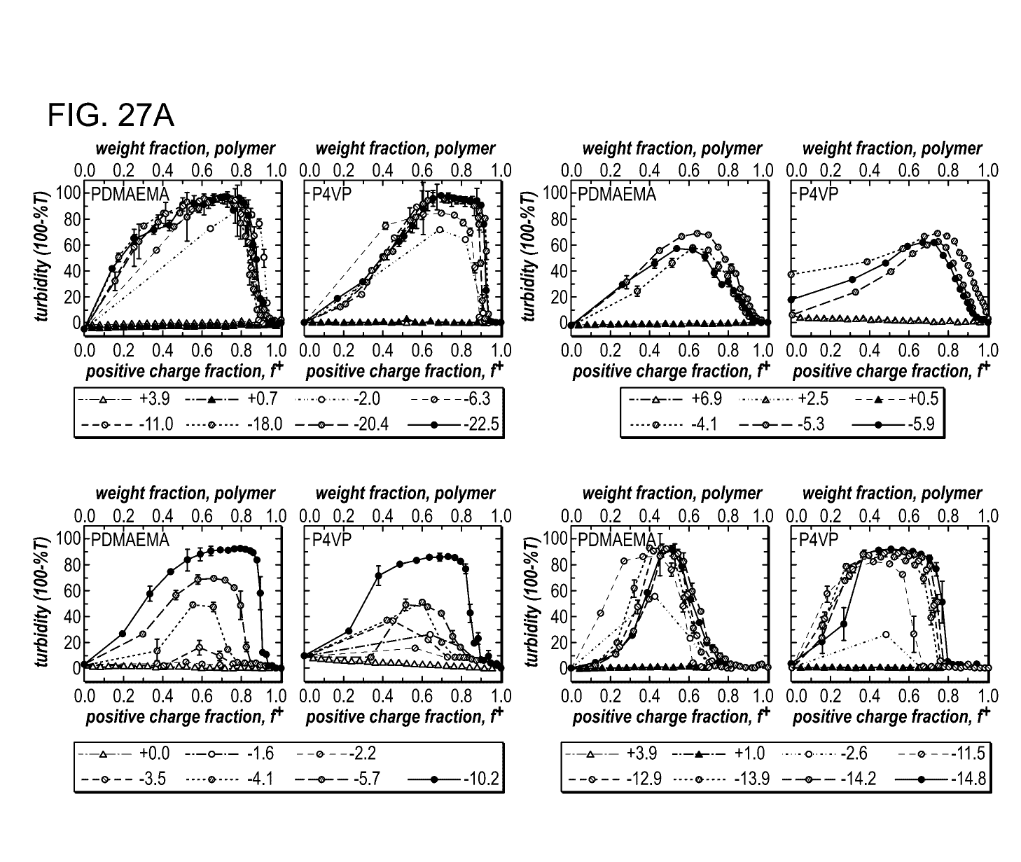

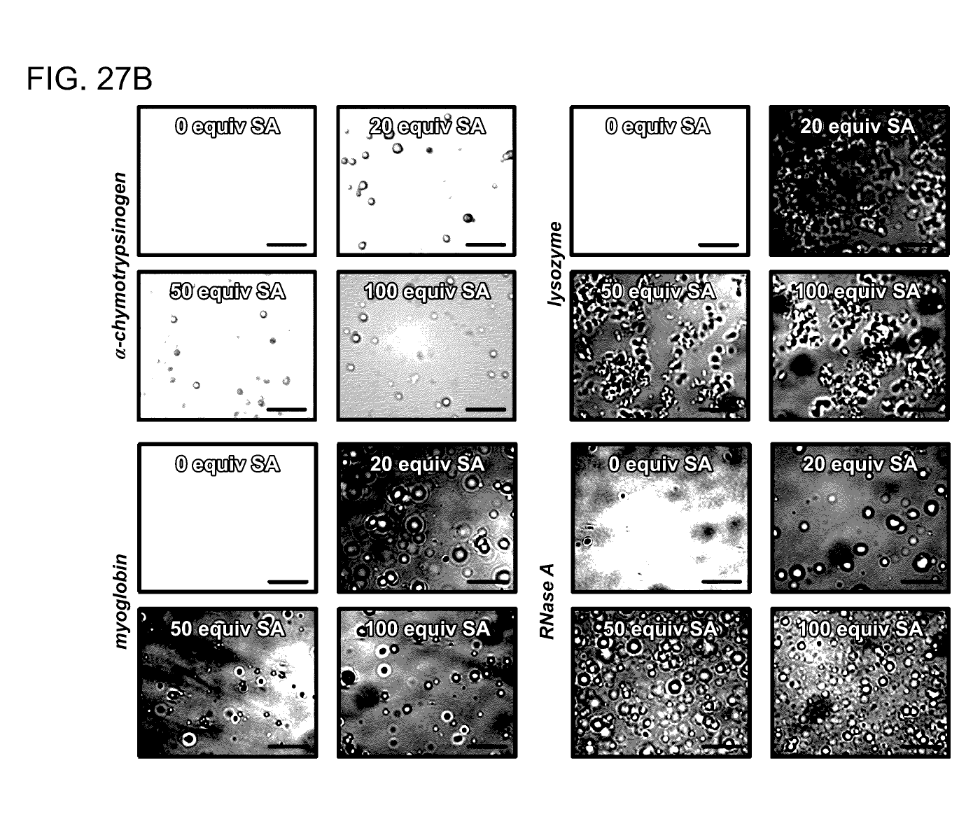

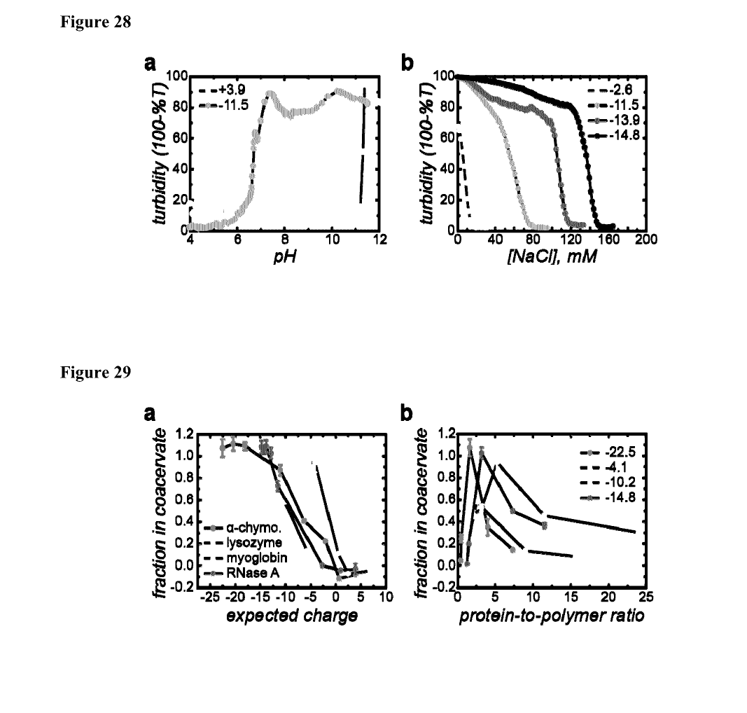

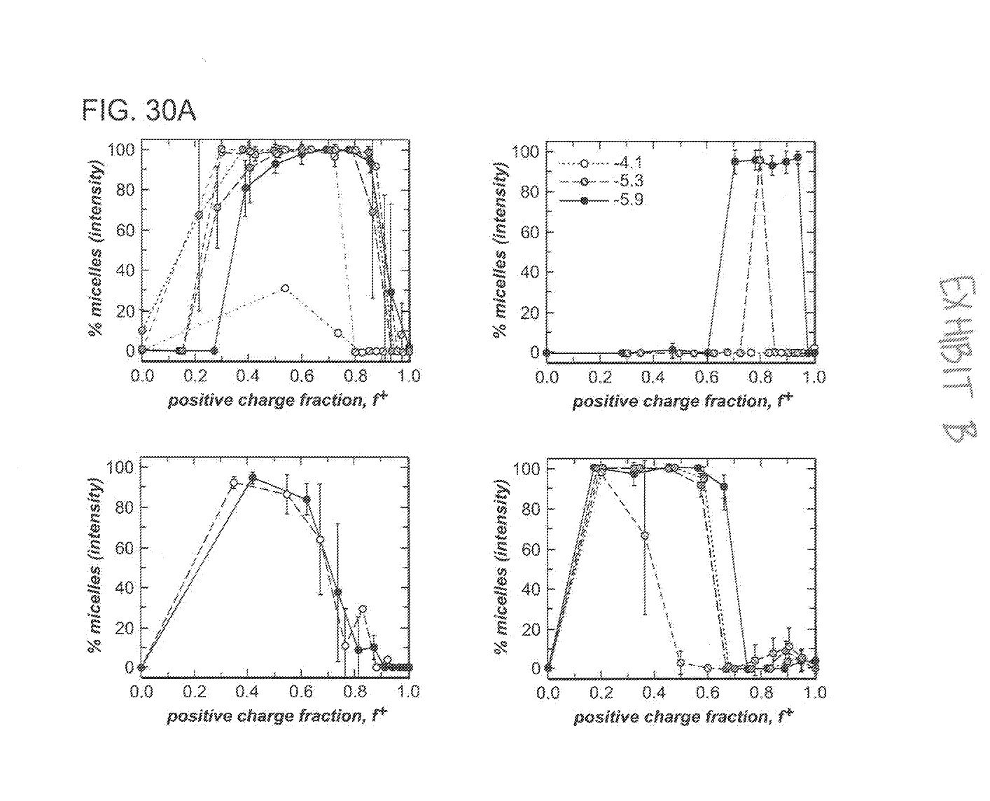

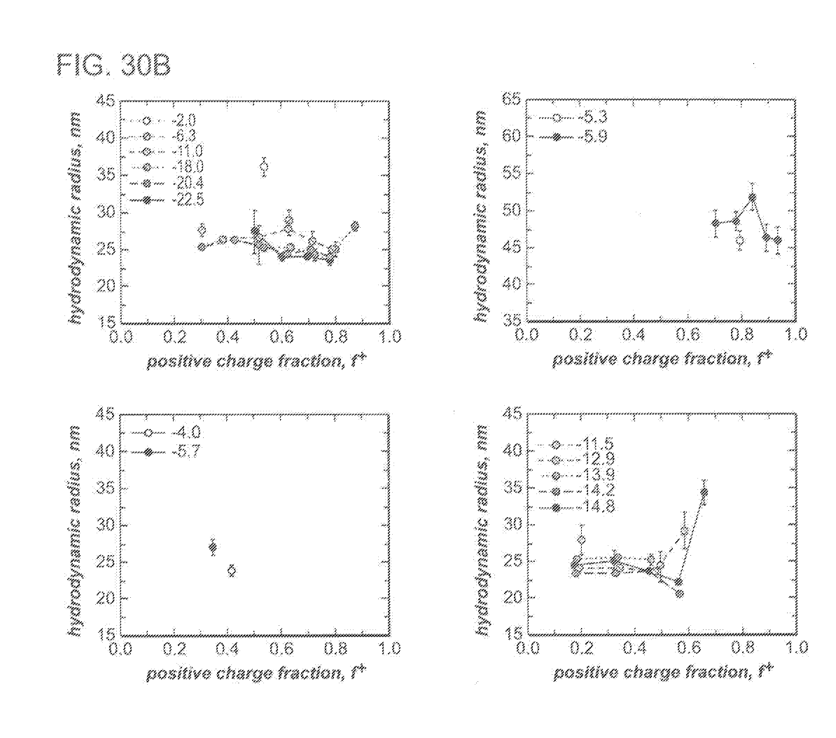

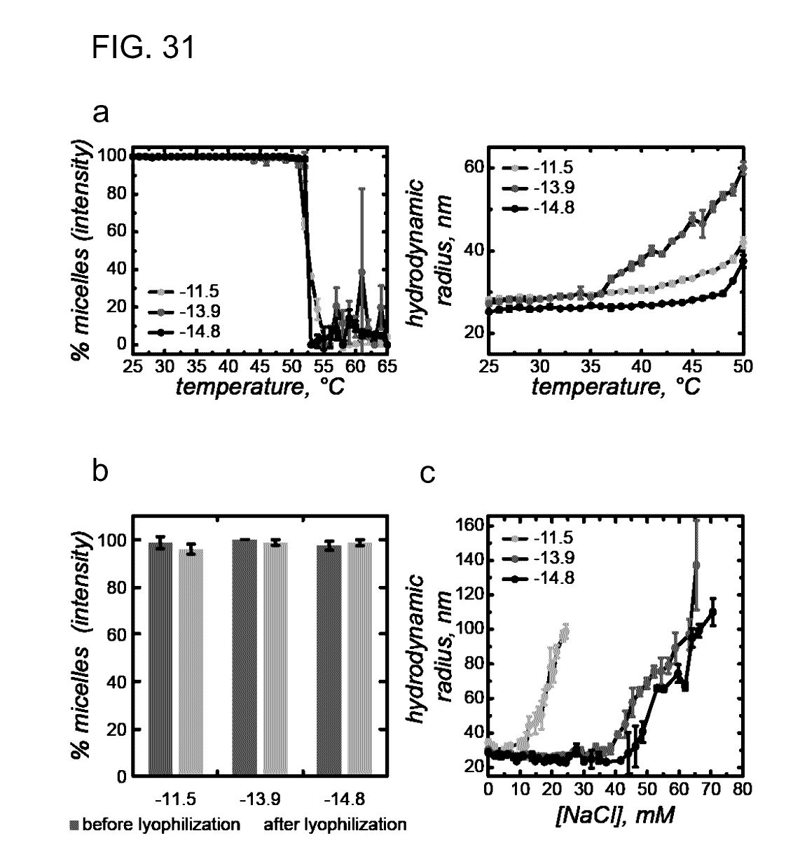

In certain embodiments, the invention relates to a composition, comprising a complex coacervate core micelle, which may act as a nanoreactor. The ionic, hydrophilic core encapsulates enzymes and water, which are necessary for hydrolysis, while the neutral corona solubilizes the micelle in organic solvent. In certain embodiments, a charged polymer is used, and may act to absorb acidic by-products (such as HF). See FIG. 2.

### Complex Coacervate Core Micelles

Complex coacervation is a known phenomenon in colloid chemistry. In general, coacervation is the phenomenon of salting out or phase separation of lyophilic colloids into liquid droplets, rather than solid aggregates. Coacervation of a polymeric ingredient can be brought about in a number of different ways, for example by a change in temperature, a change of pH, addition of a low molecular weight substance or addition of a second macromolecular substance. Two types of coacervation have been defined: simple coacervation and complex coacervation. In general, simple coacervation deals with systems containing only one polymeric ingredient, while complex coacervation deals with systems containing more than one polymeric ingredient.

So, complex coacervation is the liquid-liquid phase separation that results when solutions of two oppositely charged macro-ions are mixed, resulting in the formation of a dense macro-ion-rich phase, the precursors of which are soluble complexes. Variables, such as temperature, pH, and concentration, may be used to induce polymer phase separation, so as to produce a suspension of complex coacervate micelles.

Active agents, dyes, or proteins, such as enzymes, may be encapsulated in complex coacervate core micelles. By virtue of their encapsulation, hydrophilic “core materials” (e.g., enzymes) in an aqueous nano- or micro-environment may be dispersed in organic solvents.

### Hydrolytic Enzymes

Hydrolases are enzymes that catalyze the hydrolysis of a chemical bond.

An example of a hydrolase is organophosphate hydrolase (also known as aryldialkylphosphatase (EC 3.1.8.1), organophosphorus hydrolase, phosphotriesterase, and paraoxon hydrolase), which has a molecular weight of about 39.1 kDa, 7 lysine residues, or a pI of about 8.1, or a combination thereof.

Another example is organophosphate acid anhydrolase (also known as organophosphorus acid anhydrolase (OPAA)). The enzyme is found in a diverse range of organisms, including protozoa, squid and clams, mammals, and soil bacteria. A highly active form of the enzyme may be isolated from the marine bacteria Alteromonas undina. Organophosphate acid anhydrolase has a molecular weight of about 50.8 kDa, 21 lysine residues, or a pI of about 6.1, or a combination thereof.

Model enzymes, which may mimic the size, shape, or surface characteristics of hydrolytic enzymes, are also described herein.

For example, α-chymotrypsinogen may be used. α-Chymotrypsinogen is a proteolytic enzyme and a precursor of chymotrypsin. α-Chymotrypsinogen has a molecular weight of about 25.7 kDa, 14 lysine residues, or a pI of about 8.2, or a combination thereof.

Another model enzyme is α-amylase. An amylase is an enzyme that catalyzes the hydrolysis of starch into sugars. α-Amylase has a molecular weight of about 47.0 kDa, 17 lysine residues, or a pI of about 5.6, or a combination thereof.

Other model enzymes include, but are not limited to, lysozyme and myoglobin.

### Nerve Agents and Their Decontamination

Nerve agents are a class of phosphorus-containing organic chemicals (organophosphates) that disrupt the mechanism by which nerves transfer messages to organs. The disruption is caused by blocking acetylcholinesterase, an enzyme that normally destroys acetylcholine, a neurotransmitter.

They are chemical weapons classified as “weapons of mass destruction” by the United Nations according to UN Resolution 687 (passed in April 1991). Their production and stockpiling was outlawed by the Chemical Weapons Convention of 1993, which officially took effect on Apr. 29, 1997. The use of dangerous gases in warfare is forbidden by treaties.

Poisoning by a nerve agent leads to contraction of pupils, profuse salivation, convulsions, involuntary urination and defecation, and eventual death by asphyxiation. Some nerve agents are readily vaporized or aerosolized, and their primary portal of entry into the body is the respiratory system. Nerve agents can also be absorbed through the skin.

There are two main classes of nerve agents: G-series and V-series.

G-series agents are non-persistent, and include GA (tabun), GB (sarin), GD (soman), and GF (cyclosarin). The structures of these G-series agent are shown below.

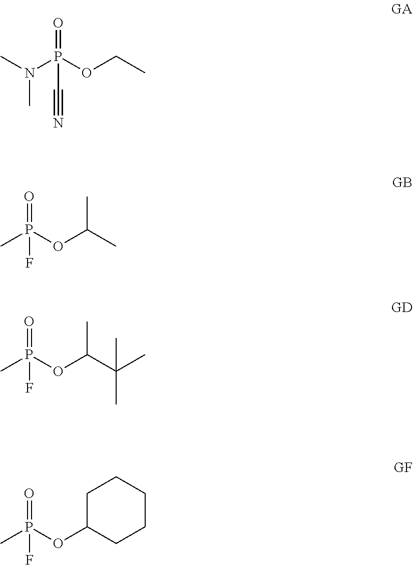

The V-series agents are persistent, meaning that these agents do not degrade or wash away easily and can, therefore, remain on clothes and other surfaces for long periods. In use, this characteristic allows the V-agents to be used to blanket terrain to guide or curtail the movement of enemy ground forces. The consistency of these agents is similar to oil; as a result, the contact hazard for V-agents is primarily—but not exclusively—dermal. Commonly known V-series agents are VE, VG, VM, VR, and VX, the structures of which are shown below.

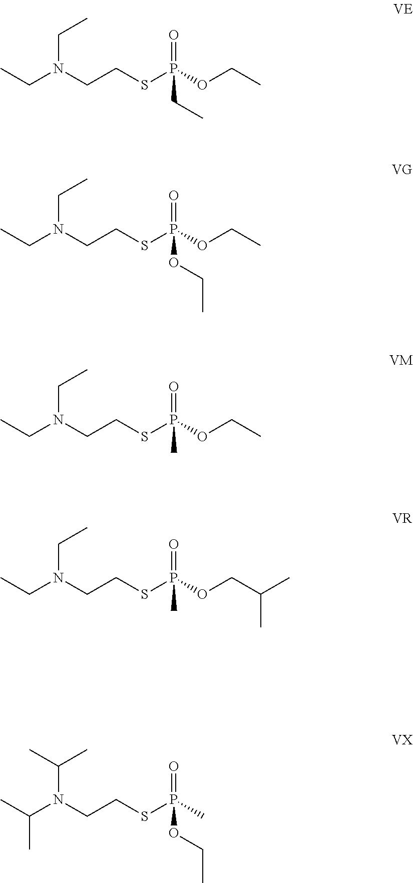

Currently there is only one therapeutic agent that provides effective protection against the entire spectrum of organophosphate nerve agents: butyrylcholinesterase. When administered prophylactically, this enzyme stoichiometrically binds the nerve agent in the bloodstream before it can exert effects on the nervous system.

Decontamination technologies for safe disposal, facility and site cleanup, and destruction of stockpiles of organophosphate nerve agents are needed to protect the environment as well as the public. According to the Department of Defense, the technology should have following properties: environmentally friendliness; capable of safe transportation, storage and handling, including long term stability; serve as a first response to protect the civilian population; be capable of restoring contaminated facilities; not affect the operation of sensitive electronic equipment; generate minimal toxic byproducts; and render treated materials suitable for disposal in a municipal waste stream.

An improved decontamination technology meeting the above listed guidelines would find immediate use in any number of existing applications, such as: destruction of stockpiles; improving military clothing and gas masks; destruction of nerve agents present in air, water, and soils; protection of occupants in specially designed rooms to prevent deadly gas permeation; degradation of ammunition wastes; development of effective topical decontaminants for personal use or decontaminant sprays for contaminated interior spaces, vehicles, aircrafts, sensitive equipment, etc.; construction of sensors; and provision of water filtration units for drinking water supplies contaminated with CWAs.

### Exemplary Nanostructures

In certain embodiments, the invention relates to a nanostructure, comprising, consisting essentially of, or consisting of:
(i) a polyanionic polymer;
   a block copolymer; and
   an enzyme; or
(ii) a block copolymer; and
   a modified enzyme.

In certain embodiments, the invention relates to any one of the nanostructures described herein, wherein the nanostructure comprises (i) a polyanionic polymer; a block copolymer; and an enzyme.

In certain embodiments, the invention relates to any one of the nanostructures described herein, wherein the nanostructure comprises (ii) a block copolymer; and a modified enzyme.

In certain embodiments, the invention relates to any one of the nanostructures described herein, wherein the nanostructure consists essentially of (i) a polyanionic polymer; a block copolymer; and an enzyme.

In certain embodiments, the invention relates to any one of the nanostructures described herein, wherein the nanostructure consists essentially of (ii) a block copolymer; and a modified enzyme.

In certain embodiments, the invention relates to any one of the nanostructures described herein, wherein the nanostructure consists of (i) a polyanionic polymer; a block copolymer; and an enzyme.

In certain embodiments, the invention relates to any one of the nanostructures described herein, wherein the nanostructure consists of (ii) a block copolymer; and a modified enzyme.

In certain embodiments, the invention relates to any one of the nanostructures described herein, wherein the nanostructure comprises (i) a polyanionic polymer; a block copolymer; an enzyme; and an aqueous liquid.

In certain embodiments, the invention relates to any one of the nanostructures described herein, wherein the nanostructure comprises (ii) a block copolymer; a modified enzyme; and an aqueous liquid.

In certain embodiments, the invention relates to any one of the nanostructures described herein, wherein the nanostructure consists essentially of (i) a polyanionic polymer; a block copolymer; an enzyme; and an aqueous liquid.

In certain embodiments, the invention relates to any one of the nanostructures described herein, wherein the nanostructure consists essentially of (ii) a block copolymer; a modified enzyme; and an aqueous liquid.

In certain embodiments, the invention relates to any one of the nanostructures described herein, wherein the nanostructure consists of (i) a polyanionic polymer; a block copolymer; an enzyme; and an aqueous liquid.

In certain embodiments, the invention relates to any one of the nanostructures described herein, wherein the nanostructure consists of (ii) a block copolymer; a modified enzyme; and an aqueous liquid.

In certain embodiments, the invention relates to any one of the nanostructures described herein, wherein the block copolymer comprises a plurality of first repeat units, and a plurality of second repeat units;

the first repeat unit is

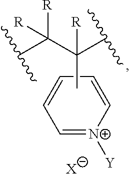

wherein, independently for each occurrence,
R is H, alkyl, halo, hydroxy, amino, nitro, or cyano;
Y is alkyl; and
X⊖ is an anion; and

the second repeat unit is

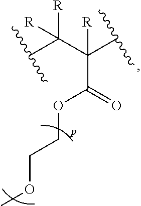

wherein, independently for each occurrence,
R is H, alkyl, halo, hydroxy, amino, nitro, or cyano; and
p is 2-20, inclusive.

In certain embodiments, the invention relates to any one of the nanostructures described herein, wherein p is 4-10, inclusive.

In certain embodiments, the invention relates to any one of the nanostructures described herein, wherein p is 4, 5, 6, 7, 8, 9, or 10.

In certain embodiments, the invention relates to any one of the nanostructures described herein, wherein R is independently H or alkyl.

In certain embodiments, the invention relates to any one of the nanostructures described herein, wherein one instance of R is alkyl.

In certain embodiments, the invention relates to any one of the nanostructures described herein, wherein one instance of R is methyl, ethyl, n-propyl, or i-propyl.

In certain embodiments, the invention relates to any one of the nanostructures described herein, wherein one instance of R is methyl.

In certain embodiments, the invention relates to any one of the nanostructures described herein, wherein three instances of R are H.

In certain embodiments, the invention relates to any one of the nanostructures described herein, wherein R is H.

In certain embodiments, the invention relates to any one of the nanostructures described herein, wherein Y is C₁-C₁₀ alkyl. In certain embodiments, the invention relates to any one of the nanostructures described herein, wherein Y is C₂-C₆ alkyl. In certain embodiments, the invention relates to any one of the nanostructures described herein, wherein Y is n-butyl.

In certain embodiments, the invention relates to any one of the nanostructures described herein, wherein X⊖ is halide, boron tetrafluoride, phosphorus tetrafluoride, phosphorus hexafluoride, alkylsulfonate, fluoroalkylsulfonate, arylsulfonate, bis(alkylsulfonyl)amide, bis(fluoro alkylsulfonyl)amide, bis(arylsulfonyl)amide, (fluoroalkylsulfonyl)(fluoroalkylcarbonyl)amide, nitrate, nitrite, sulfate, hydrogensulfate, alkyl sulfate, aryl sulfate, carbonate, bicarbonate, carboxylate, phosphate, hydrogen phosphate, dihydrogen phosphate, or hypochlorite.

In certain embodiments, the invention relates to any one of the nanostructures described herein, wherein X⊖ is halide.

In certain embodiments, the invention relates to any one of the nanostructures described herein, wherein X⊖ is bromide, chloride, or iodide.

In certain embodiments, the invention relates to any one of the nanostructures described herein, wherein X⊖ is bromide.

In certain embodiments, the invention relates to any one of the nanostructures described

herein, wherein the molecular weight of the

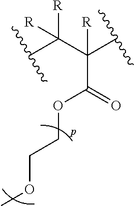

block is about 12 kDa to about 60 kDa.

In certain embodiments, the invention relates to any one of the nanostructures described

herein, wherein the molecular weight of the

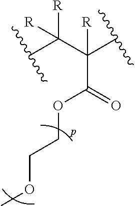

block is about 15 kDa, about 20 kDa, about 25 kDa, about 30 kDa, about 35 kDa, about 40 kDa, about 45 kDa, about 50 kDa, or about 55 kDa.

In certain embodiments, the invention relates to any one of the nanostructures described

herein, wherein the molecular weight of the

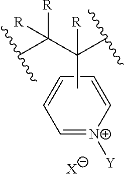

block is about 5 kDa to about 30 kDa.

In certain embodiments, the invention relates to any one of the nanostructures described

herein, wherein the molecular weight of the

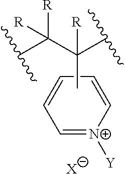

block is about 6 kDa, about 8 kDa, about 10 kDa, about 12 kDa, about 14 kDa, about 16 kDa, about 18 kDa, about 20 kDa, about 22 kDa, about 24 kDa, about 26 kDa, or about 28 kDa.

In certain embodiments, the invention relates to any one of the nanostructures described herein, wherein the molecular weight of the block copolymer is about 18 kDa to about 74 kDa.

In certain embodiments, the invention relates to any one of the nanostructures described herein, wherein the molecular weight of the block copolymer is about 20 kDa, about 25 kDa, about 30 kDa, about 35 kDa, about 40 kDa, about 45 kDa, about 50 kDa, about 55 kDa, about 60 kDa, about 65 kDa, or about 70 kDa.

In certain embodiments, the invention relates to any one of the nanostructures described herein, wherein the block copolymer further comprises a first end-group; and the first end-group

has the following structure:

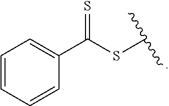 [SMILES: *SC(=S)c1ccccc1]

In certain embodiments, the invention relates to any one of the nanostructures described herein, wherein the block copolymer further comprises a second end-group; and the second end-group has the following structure:

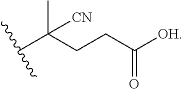 [SMILES: *C(C)(C#N)CCC(=O)O]

In certain embodiments, the invention relates to any one of the nanostructures described herein, wherein the block copolymer is a diblock copolymer.

In certain embodiments, the invention relates to any one of the nanostructures described herein, wherein the block copolymer has the following structure:

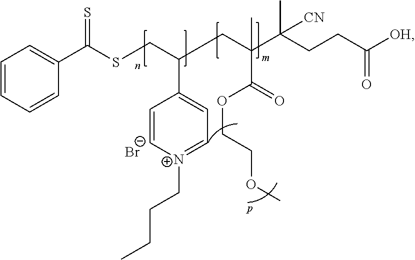

wherein n is 50 to 150, inclusive; and m is 60 to 200, inclusive.

In certain embodiments, the invention relates to any one of the nanostructures described herein, wherein n is about 60, about 70, about 80, about 90, about 100, about 110, about 120, about 130, or about 140.

In certain embodiments, the invention relates to any one of the nanostructures described herein, wherein m is about 70, about 80, about 90, about 100, about 110, about 120, about 130, about 140, about 150, about 160, about 170, about 180, or about 190.

In certain embodiments, the invention relates to any one of the nanostructures described herein, wherein the enzyme or modified enzyme is an organophosphate hydrolase or a modified organophosphate hydrolase.

In certain embodiments, the invention relates to any one of the nanostructures described herein, wherein the enzyme or modified enzyme is an organophosphate acid anhydrolase or a modified organophosphate acid anhydrolase.

In certain embodiments, the invention relates to any one of the nanostructures described herein, wherein the enzyme or modified enzyme is α-chymotrypsinogen or modified α-chymotryp sino gen.

In certain embodiments, the invention relates to any one of the nanostructures described herein, wherein the enzyme or modified enzyme is an α-amylase or a modified α-amylase.

In certain embodiments, the invention relates to any one of the nanostructures described herein, wherein the enzyme or modified enzyme is a lysozyme or a modified lysozyme.

In certain embodiments, the invention relates to any one of the nanostructures described herein, the enzyme or modified enzyme is a myoglobin or a modified myoglobin.

In certain embodiments, the invention relates to any one of the nanostructures described herein, wherein the molecular weight of the enzyme or the modified enzyme is about 20 kDa to about 60 kDa.

In certain embodiments, the invention relates to any one of the nanostructures described herein, wherein the molecular weight of the enzyme or the modified enzyme is about 22 kDa, about 23 kDa, about 24 kDa, about 25 kDa, about 26 kDa, about 27 kDa, about 28 kDa, about 29 kDa, about 30 kDa, about 31 kDa, about 32 kDa, about 33 kDa, about 34 kDa, about 35 kDa, about 36 kDa, about 37 kDa, about 38 kDa, about 39 kDa, about 40 kDa, about 41 kDa, about 42 kDa, about 43 kDa, about 44 kDa, about 45 kDa, about 46 kDa, about 47 kDa, about 48 kDa, about 49 kDa, about 50 kDa, about 51 kDa, about 52 kDa, or about 53 kDa.

In certain embodiments, the invention relates to any one of the nanostructures described herein, wherein the temperature of the nanostructure is about 18° C. to about 50° C.

In certain embodiments, the invention relates to any one of the nanostructures described herein, wherein the temperature of the nanostructure is about 20° C. , about 22° C., about 24° C., about 26° C., about 28° C., about 30° C., about 32° C., about 34° C., about 36° C., about 38° C., about 40° C., about 42° C., about 44° C., about 46° C., or about 48° C.

In certain embodiments, the invention relates to any one of the nanostructures described herein, wherein the temperature of the nanostructure is about 23° C.

In certain embodiments, the invention relates to any one of the nanostructures described herein, wherein the temperature of the nanostructure is about 37° C.

In certain embodiments, the invention relates to any one of the nanostructures described herein, wherein the positive charge fraction f⁺ is about 0.1 to about 0.5.

In certain embodiments, the invention relates to any one of the nanostructures described herein, wherein the positive charge fraction f⁺ is about 0.2 to about 0.4.

In certain embodiments, the invention relates to any one of the nanostructures described herein, wherein the positive charge fraction f⁺ is about 0.3.

In certain embodiments, the invention relates to any one of the nanostructures described herein, wherein the nanostructure is a nanostructure of form (i); and the polyanionic polymer is polyacrylic acid.

In certain embodiments, the invention relates to any one of the nanostructures described herein, wherein the molecular weight of the polyacrylic acid is about 2 kDa to about 10 kDa.

In certain embodiments, the invention relates to any one of the nanostructures described herein, wherein the molecular weight of the polyacrylic acid is about 3 kDa, about 4 kDa, about 5 kDa, about 6 kDa, about 7 kDa, about 8 kDa, or about 9 kDa.

In certain embodiments, the invention relates to any one of the nanostructures described herein, wherein the nanostructure is a nanostructure of form (ii); and the modified enzyme comprises at least one non-natural pendant anionic moiety.

In certain embodiments, the invention relates to any one of the nanostructures described herein, wherein the modified enzyme comprises at least two, at least three, at least four, at least five, at least six, at least seven, at least eight, at least nine, or at least 10 non-natural pendant anionic moieties.

In certain embodiments, the invention relates to any one of the nanostructures described herein, wherein the modified enzyme comprises about two, about three, about four, about five, about six, about seven, about eight, about nine, about 10, about 11, about 12, about 13, about 14, about 15, about 16, about 17, about 18, about 19, or about 20 non-natural pendant anionic moieties.

In certain embodiments, the invention relates to any one of the nanostructures described herein, wherein the pendant anionic moiety is covalently bonded to a lysine residue.

In certain embodiments, the invention relates to any one of the nanostructures described herein, wherein the pendant anionic moiety is a carboxylate moiety.

In certain embodiments, the invention relates to any one of the nanostructures described herein, wherein the zeta potential of the modified enzyme is less than about −40 mV.

In certain embodiments, the invention relates to any one of the nanostructures described herein, wherein the zeta potential of the modified enzyme is from about −40 mV to about −70 mV.

In certain embodiments, the invention relates to any one of the nanostructures described herein, wherein the zeta potential of the modified enzyme is about −40 mV, about −50 mV, about −60 mV, or about −70 mV.

In certain embodiments, the invention relates to any one of the nanostructures described herein, wherein the nanostructure further comprises an aqueous liquid.

In certain embodiments, the invention relates to any one of the nanostructures described herein, wherein the aqueous liquid comprises a buffer.

In certain embodiments, the invention relates to any one of the nanostructures described herein, wherein the buffer is selected from the group consisting of: N-(2-acetamido)-2-aminoethanesulfonic acid (aces), N-(2-acetamido)iminodiacetic acid (ADA), acetate, 2-amino-2-methyl-1,3-propanediol (AMPD), 2-amino-2-methyl-1-propanol (AMP), N,N-bis(2-hydroxyethyl)-2-aminoethanesulfonic acid (BES), 3-(N,N-bis[2-hydroxyethyl]amino)-2-hydroxypropanesulfonic acid (DIPSO), N,N-bis(2-hydroxyethyl)glycine (Bicine), bis(2-hydroxyethyl)iminotris(hydroxymethyl)methane (Bis-Tris), 1,3-bis[tris(hydroxymethyl)methylamino]propane (Bis-Tris propane), borate, citrate, 4-(cyclohexylamino)-1-butanesulfonic acid (CABS), 2-(cyclohexylamino)ethanesulfonic acid (CHES), 3-(cyclohexylamino)-2-hydroxy-1-propanesulfonic acid (CAPSO), 3-(cyclohexylamino)-1-propanesulfonic acid (CAPS), diglycine (Gly-Gly), 3-([1,1-dimethyl-2-hydroxyethyl]amino)-2-hydroxypropanesulfonic acid (AMPSO), glycine, 2-[(2-hydroxy-1,1-bis[hydroxymethyl]ethyl)amino]ethanesulfonic acid (TES), N-(2-hydroxyethyl)piperazine-N′-(4-butanesulfonic acid) (HEPBS), N-(2-hydroxyethyl)-piperazine-N′-ethanesulfonic acid (HEPES), 4-(2-hydroxyethyl)-1-piperazinepropanesulfonic acid (EPPS), 4-(N-morpholino)butanesulfonic acid (MOBS), 2-(N-morpholino)ethanesulfonic acid (MES), 3-(N-morpholino)propanesulfonic acid (MOPS), 3-(N-morpholinyl)-2-hydroxypropanesulfonic acid (MOPSO), phosphate, piperazine-N,N′-bis(2-hydroxypropanesulfonic acid) (POPSO), 1,4-piperazinediethanesulfonic acid (PIPES), tris(hydroxymethyl)aminomethane (Tris), 3-(N-tris[hydroxymethyl]methylamino)-2-hydroxypropanesulfonic acid (TAP SO), N-tris(hydroxymethyl)methyl-3-aminopropanesulfonic acid (TAPS), and N-[tris(hydroxymethyl)methyl]glycine (Tricine).

In certain embodiments, the invention relates to any one of the nanostructures described herein, wherein the concentration of buffer in the aqueous liquid is about 10 mM to about 100 mM.

In certain embodiments, the invention relates to any one of the nanostructures described herein, wherein the concentration of buffer in the aqueous liquid is about 20 mM, about 30 mM, about 40 mM, about 50 mM, about 60 mM, about 70 mM, about 80 mM, or about 90 mM.

In certain embodiments, the invention relates to any one of the nanostructures described herein, wherein the concentration of buffer in the aqueous liquid is about 50 mM.

In certain embodiments, the invention relates to any one of the nanostructures described herein, wherein the pH of the aqueous liquid is about 6.5, about 7.0, about 7.5, about 8.0, about 8.5, about 9.0, or about 9.5.

In certain embodiments, the invention relates to any one of the nanostructures described herein, wherein the pH of the aqueous liquid is about 8.0.

In certain embodiments, the invention relates to any one of the nanostructures described herein, wherein the nanostructure is a nanostructure of form (i); and the enzyme is substantially encapsulated by the block copolymer.

In certain embodiments, the invention relates to any one of the nanostructures described herein, wherein the nanostructure is a nanostructure of form (i); and the polyanionic polymer is substantially encapsulated by the block copolymer.

In certain embodiments, the invention relates to any one of the nanostructures described herein, further comprising an aqueous liquid, wherein the nanostructure is a nanostructure of form (i); and the aqueous liquid is substantially encapsulated by the block copolymer.

In certain embodiments, the invention relates to any one of the nanostructures described herein, wherein the nanostructure is a nanostructure of form (ii); and the modified enzyme is substantially encapsulated by the block copolymer.

In certain embodiments, the invention relates to any one of the nanostructures described herein, further comprising an aqueous liquid, wherein the nanostructure is a nanostructure of form (ii); and the aqueous liquid is substantially encapsulated by the block copolymer.

In certain embodiments, the invention relates to any one of the nanostructures described herein, wherein the hydrodynamic radius of the nanostructure is about 1.5 nm to about 60 nm.

In certain embodiments, the invention relates to any one of the nanostructures described herein, wherein the hydrodynamic radius of the nanostructure is about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, about 50 nm, about 51 nm, about 52 nm, about 53 nm, about 54 nm, about 55 nm, about 56 nm, about 57 nm, about 58 nm, about 59 nm, or about 60 nm.

In certain embodiments, the invention relates to any one of the nanostructures described herein, wherein the radius of the nanostructure, as determined by SANS, is about 10 nm to about 25 nm.

In certain embodiments, the invention relates to any one of the nanostructures described herein, wherein the radius of the nanostructure, as determined by SANS, is about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, or about 25 nm.

### Exemplary Compositions

In certain embodiments, the invention relates to a composition, comprising, consisting essentially of, or consisting of:
an organic phase, an aqueous liquid phase, and a plurality of any of the nanostructures described herein.

In certain embodiments, the invention relates to any of the compositions described herein, wherein the compositions comprises an organic phase, an aqueous liquid phase, and a plurality of any of the nanostructures described herein.

In certain embodiments, the invention relates to any of the compositions described herein, wherein the composition consists essentially of an organic phase, an aqueous liquid phase, and a plurality of any of the nanostructures described herein.

In certain embodiments, the invention relates to any of the compositions described herein, wherein the composition consists of an organic phase, an aqueous liquid phase, and a plurality of any of the nanostructures described herein.

In certain embodiments, the invention relates to any of the compositions described herein, wherein the organic phase is an organic liquid phase.

In certain embodiments, the invention relates to any of the compositions described herein, wherein the organic phase comprises ethanol.

In certain embodiments, the invention relates to any of the compositions described herein, wherein the organic phase consists essentially of ethanol.

In certain embodiments, the invention relates to any of the compositions described herein, wherein the organic phase consists of ethanol.

In certain embodiments, the invention relates to any of the compositions described herein, wherein the organic phase comprises DMMP.

In certain embodiments, the invention relates to any of the compositions described herein, wherein the organic phase consists essentially of DMMP.

In certain embodiments, the invention relates to any of the compositions described herein, wherein the organic phase consists of DMMP.

In certain embodiments, the invention relates to any of the compositions described herein, wherein the total concentration of block copolymer and polyanionic polymer in the composition is about 1 mg/mL to about 40 mg/mL.

In certain embodiments, the invention relates to any of the compositions described herein, wherein the total concentration of block copolymer and polyanionic polymer in the composition is about 2 mg/mL, about 4 mg/mL, about 6 mg/mL, about 8 mg/mL, about 10 mg/mL, about 12 mg/mL, about 14 mg/mL, about 16 mg/mL, or about 18 mg/mL.

In certain embodiments, the invention relates to any of the compositions described herein, wherein the concentration of block copolymer in the composition is about 1 mg/mL to about 40 mg/mL.

In certain embodiments, the invention relates to any of the compositions described herein, wherein the concentration of block copolymer in the composition is about 2 mg/mL, about 4 mg/mL, about 6 mg/mL, about 8 mg/mL, about 10 mg/mL, about 12 mg/mL, about 14 mg/mL, about 16 mg/mL, or about 18 mg/mL.

In certain embodiments, the invention relates to any of the compositions described herein, wherein the concentration of enzyme or modified enzyme in the composition is about 1 mg/mL to about 40 mg/mL.

In certain embodiments, the invention relates to any of the compositions described herein, wherein the concentration of enzyme or modified enzyme in the composition is about 2 mg/mL, about 4 mg/mL, about 6 mg/mL, about 8 mg/mL, about 10 mg/mL, about 12 mg/mL, about 14 mg/mL, about 16 mg/mL, or about 18 mg/mL.

In certain embodiments, the invention relates to any of the compositions described herein, wherein the volume ratio of organic phase to aqueous liquid phase is about 99:1 to about 90:10.

In certain embodiments, the invention relates to any of the compositions described herein, wherein the volume ratio of organic phase to aqueous liquid phase is about 98:2: about 97:3, about 96:4, about 95:5, or about 94:6.

### Exemplary Methods

In certain embodiments, the invention relates to a method of hydrolyzing an organophosphorous compound, comprising contacting the organophosphorous compound with an effective amount of any of the nanostructures or compositions described herein.

In certain embodiments, the invention relates to a method of decontaminating an area or a device contaminated with an organophosphorous compound, comprising contacting the area or the device with an effective amount of any of the nanostructures or compositions described herein.

In certain embodiments, the invention relates to any of the methods described herein, wherein the area contaminated with the organophosphorus compound is on the skin of a human or an animal.

In certain embodiments, the invention relates to any of the methods described herein, wherein the area contaminated with the organophosphorus compound is on the clothing of a human.

In certain embodiments, the invention relates to any of the methods described herein, wherein the method is a catalytic method.

In certain embodiments, the invention relates to any of the methods described herein, wherein the organophosphorus compound is selected from the group consisting of: GA, GB, GD, GF, VE, VG, VM, VR, and VX.

### EXEMPLIFICATION

The invention now being generally described, it will be more readily understood by reference to the following, which is included merely for purposes of illustration of certain aspects and embodiments of the present invention, and is not intended to limit the invention.

### Example 1

### Improving Coacervation by Using Supercharged Proteins

General Methods. Unless otherwise noted, the chemicals and solvents used were of analytical grade and were used as received from commercial sources. All organic solvents were removed under reduced pressure using a rotary evaporator or vacuum oven. Purification of small molecules was achieved using a Biotage Isolera One system. Water (dd-H₂O) used as a buffer medium was deionized using a Millipore Milli-Q Academic purification system (Millipore). Centrifugations were performed with a Sorvall Legend Micro 21 (Thermo Scientific). Methyl quaternized poly(4-vinylpyridine) was purchased from Polymer Source (M_{w}/Mₙ=1.20, Mₙ=12,000). Myoglobin, α-chymotrypsinogen, and lysozyme were purchased from Sigma-Aldrich. RNase A was purchased from Akron Biotechnology.

Synthesis of qPDMAEMA. Reversible addition-fragmentation chain transfer (RAFT) polymerization was used to synthesize homopolymer from 2-(dimethylamino)ethyl methacrylate (DMAEMA) (98%, Aldrich) with a narrow molecular weight distribution. DMAEMA was passed through a basic alumina column prior to polymerization to remove inhibitors. 2-hydroxyethyl 2-(((ethylthio)carbonothioyl)thio)-2-methylpropanoate (EMP-OH) was prepared as the RAFT chain transfer agent as described in the Supporting Information. EMP-OH (134 mg, 0.5 mmol) and azobisisobutryonitrile (AIBN, recrystallized twice from methanol, 16.4 mg, 0.1 mmol) were added to a solution of DMAEMA (24 g, 150 mmol) in 24 g 1,4-dioxane in the ratio of 300:1:0.2. The solution was degassed by three freeze-pump-thaw cycles. The polymerization was carried out in a sealed flask at 75° C. and terminated after 3 h by removal of heat and exposure to oxygen. The polymer was then precipitated in cold hexanes and dried under vacuum. The polymerization provided a well-defined polymer with a molecular weight Mₙ=20.9 kg/mol with a dispersity of 1.59. PDMAEMA (8 g) was quaternized with iodomethane (99%, Sigma-Aldrich, 13 mL) in N,N-dimethylformamide (DMF). The reaction mixture was stirred at room temperature for 24 h and then the modified polymer was precipitated in diethyl ether and dried under vacuum. The degree of quaternization was >95% as determined by ¹H NMR.

Synthesis of POEGMA-b-qP4VP. RAFT polymerization was used to synthesize a block copolymer from 4-vinylpyridine (4VP) (95%, Aldrich) and oligo(ethylene glycol) methyl ether methacrylate (OEGMA, Mₙ=300 g/mol) (Aldrich) with a narrow molecular weight distribution. OEGMA and 4VP were passed through basic alumina columns prior to polymerization to remove inhibitors. 4-cyano-4-(phenylcarbonothioylthio)pentanoic acid (Aldrich, 155 mg, 0.56 mmol) and AIBN (recrystallized twice from methanol, 18.2 mg, 0.11 mmol) were added to a solution of OEGMA (30 g, 100 mmol) in 90 g 1,4-dioxane in the ratio of 180:1:0.2. The solution was degassed by three freeze-pump-thaw cycles. The polymerization was carried out in a sealed flask at 65° C. and terminated after 7 h by removal of heat and exposure to oxygen. The polymer was then precipitated in hexanes and dried under vacuum. The POEGMA homopolymer (Mₙ=37.1 kg/mol, D=1.15) was then used as a macromolecular chain transfer agent for RAFT polymerization of 4VP. 4VP (2.43 g, 23.1 mmol) and AIBN (2.3 mg, 0.01 mmol) were added to a solution of POEGMA in 6 g of a mixture of 1,4-dioxane and DMF in the ratio of 350:1.0:0.2 (monomer:CTA:initator). The polymerization was carried out in a sealed flask at 75° C. and terminated after 6 h by removal of heat and exposure to oxygen. The polymer was then precipitated in diethyl ether and dried under vacuum. The polymerization provided a well-defined POEGMA-b-P4VP diblock copolymer of molecular weight Mₙ=48.5 kg/mol with a dispersity of 1.13. The block copolymer was quaternized with iodomethane in DMF. The reaction mixture was stirred at room temperature for 24 h and then the modified polymer was precipitated in diethyl ether and dried under vacuum. The degree of quaternization was >95% as determined by ¹H NMR.

Supercharging of proteins with succinic anhydride. Lyophilized proteins (200 mg) were dissolved in 50 mM phosphate buffer, pH 8.0 at a concentration of 5 mg/mL. Solid succinic anhydride (2.5-200 equiv.) was added to initiate the reaction. Reaction mixtures were briefly vortexed then incubated overnight at room temperature. The modified proteins were purified by dialysis against 10 mM tris buffer, pH 8.0. The protein concentration was determined by a bicinchoninic acid (BCA) assay after dialysis and used for subsequent dilutions. Proteins were stored at 4° C. until use.

Sample preparation. Stock solutions of qPDMAEMA₁₃₃, qP4VP₁₁₄, and POEGMA₁₂₄-b-qP4VP₁₀₈ were prepared by dissolving the polymers in 10 mM tris buffer, pH 8.0. Protein solutions were prepared by diluting the initial solution of protein in 10 mM tris buffer, pH 8.0 to the desired final concentration. All solutions were filtered through 0.20 μm inorganic membrane syringe filters (Whatman).

Turbidimetric titrations. Protein and polymer samples were prepared at 2 mg/mL in 10 mM tris buffer, pH 8.0. Turbidity was used to qualitatively measure the extent of complex formation as a function of charge stoichiometry and salt concentration. To vary the charge stoichiometry, the protein and polymer solutions were mixed at ratios varying from 100% protein to 100% polymer in 4% increments of polymer. Samples were prepared in triplicate in a 96 well plate and the percent transmittance was measured on a plate reader at 600 nm or 750 nm (myoglobin). Error bars on the plots represent the calculated standard deviation of the data. To vary the salt concentration, supercharged RNase A samples were mixed with qP4VP at the protein-to-polymer ratio (r) determined from the charge stoichiometry experiments with a final total volume of 3.0 mL. Sodium chloride (1 M in 10 mM tris buffer, pH 8.0) was added in 1 uL increments and the % transmittance was monitored with a Cary 50 Bio UV/Vis spectrophotometer.

Determining protein concentration in the coacervate phase. Protein and polymer samples were prepared at 2 mg/mL in 10 mM tris buffer, pH 8.0. The samples were mixed at the protein-to-polymer ratio in the middle of the coacervation range determined by turbidimetric titration. If the protein sample did not form a coacervate phase it was mixed at the ratio determined for the protein closest in charge that did coacervate. The protein and polymer samples were briefly vortexed and then centrifuged for 10 minutes at 14,800 rpm. The dilute phase was removed by pipet and the coacervate phase was resuspended in an equal volume of 10 mM tris buffer, pH 8.0 with 500 mM NaCl. The protein concentration was determined in triplicate in both the dilute and coacervate phases using a BCA assay (Pierce) following the manufacturer's instructions.

Dynamic light scattering measurements. Protein and polymer samples were prepared at 4 mg/mL in 10 mM tris buffer, pH 8.0. Encapsulation of proteins with the block copolymer was achieved by first diluting the protein stock solution in 10 mM tris buffer, pH 8.0 to the desired concentration, followed by addition of the polymer. After mixing, samples were allowed to equilibrate at 4° C. for at least 24 h before measurements. For each sample, DLS measurements were repeated three times and involved collection of 5-10 light scattering intensity fluctuation traces. Additionally, samples were prepared in triplicate. Error bars on the plots represent the calculated standard deviation of the data. For micellar compositions, when the standard deviation in the average radius was larger than 3 nm, the value was determined to be unreliable and the radius value was not plotted.

### Example 2

### Improving Coacervation by Adding a Polyanionic Polymer

Materials. Poly(acrylic acid sodium salt), α-chymotrypsinogen, and methyl-paraoxon were purchased from Sigma Aldrich (product # 447013, C4879, and 46192). The following chemicals were used as received: Methyl iodide (CH₃I, Aldrich, >99%), 4-cyano-4-(phenylcarbonothioylthio)pentanoic acid (CPP, Aldrich, >97%), hexanes (ACS grade, VWR), N,N-dimethylformamide (DMF, Aldrich, 99%), and 1,4-dioxane (anhydrous, 99.8%). 2,2′-Azobisisobutyronitrile (AIBN, Aldrich, 98%) was purified by recrystallization from ethanol. Oligo(ethylene glycol) methyl ether methacrylate (OEGMA, average Mn=300 g/mol, Aldrich) and 4-vinyl pyridine (4VP, Aldrich, >95%) were purified over basic alumina prior to use.

OPH Expression and Purification. OPH gene in pET15b expression plasmid (Novagen, USA) was expressed and purified as described elsewhere with minor modifications. OPH enzymes were expressed in the presence of 1 mM CoCl₂ only for the last 3 hours of expression. Resuspension of the frozen cells was done without DNase or RNase A, and 0.25 mg/mL lysozyme was added instead. OPH enzymes were dialyzed into 50 mM HEPES (pH 8), and 0.1 mM CoCl₂.

Polymerization and Quaternization. Block copolymers were synthesized in a two-step reversible addition-fragmentation chain transfer (RAFT) polymerization, followed by a quaternization process. 4-cyano-4-(phenylcarbonothioylthio)pentanoic acid (CPP) was used as chain transfer agent and AIBN as initiator.

CPP (27.9 mg, 0.1 mmol), AIBN (3.3 mg, 0.02 mmol), and OEGMA (5.6 g) were dissolved in 11.2 g 1,4-dioxane in a reaction flask equipped with a magnetic stirrer. The mixture was degassed by three freeze-pump-thaw cycles, followed by polymerization at 65° C. for a prescribed time. After that, the polymerization was terminated by removal of heat and exposure to ambient air. By adding the polymer solution into an excess of hexanes, POEGMA homopolymer was obtained as a dark red oily sample.

POEGMA (2.4 g, Mn=24,000 g/mol, 0.1 mmol), AIBN (3.3 mg, 0.02 mmol), and 4VP (2.4 g) were dissolved in a mixture of DMF and 1,4-dioxane (v:v=1:1) in a reaction flask. After three freeze-pump-thaw cycles, the flask was placed in an oil bath at 70° C. for a prescribed time. The polymerization was terminated by removal of heat and exposure to ambient air. The block copolymer POEGMA-b-P4VP was obtained by participating in an excess of cold ether and dried under vacuum overnight.

POEGMA-b-P4VP (3.0 g, Mn=36,000 g/mol) was dissolved in 10 mL of DMF. An excess of methyl iodide was added. The mixture was stirred at room temperature overnight. Quaternized block copolymer was obtained by precipitating in an excess of cold ether for three times.

Sample Preparation. Aqueous polymer-only micelle samples were mixed at room temperature and then mixed at 4° C. overnight prior to measurement. Samples were allowed to come to room temperature prior to measurement. Aqueous micelle samples containing protein were prepared by first mixing PAA and the protein of interest for at least 30 minutes. Block copolymer was then added, and the sample was allowed to mix overnight at 4° C. All protein samples were kept at 4° C. until just before measurements were performed. All samples containing organic solvents were prepared at 100 mg/mL (25×) polymer in pH 8 HEPES buffer of specified concentration and allowed to equilibrate overnight at this concentration. Organic solvent content was added in such that the increase in organic solvent content of the solution never exceeded 10%. Samples were mixed using a vortexer and centrifuged briefly between organic solvent additions. Final concentration in organic solvent was 4 mg/mL total polymer, unless otherwise specified. Organic solvent solutions were allowed to mix at 4° C. overnight before measurement. Polymer-only samples were brought to room temperature prior to measurement, and protein-containing samples were kept at 4° C. until the time of measurement.

Turbidimetry. A Tecan Infinite® M200 Pro microplate reader was used to measure absorbance of 150 μL samples (at various polymer/protein ratios, specified in the plot) at a wavelength of 750 nm in a Corning® 96 Well Black with Clear Flat Bottom Polystyrene Not Treated Microplate (Product #3631). Total protein/polymer concentration was held constant at 4 mg/mL in all samples. Separate polymer/protein solutions were prepared in buffer and mixed in the plate. Measurements were performed within 10 minutes of preparation to prevent the settling of the coacervate phase. Each data point was measured in triplicate. Absorbance was converted to transmittance using the following equation:

% T=10^{-A}

Dynamic Light Scattering. All dynamic light scattering measurements were done on a Wyatt Möbiuζ with a 532 nm laser in a 45 μL quartz cuvette.

All samples were prepared at a total polymer concentration of 4 mg/mL unless otherwise specified. All aqueous polymer and protein samples were filtered through a 0.1 μm syringe filter prior to mixing to prevent dust from affecting the integrity of light scattering data. All DMMP and ethanol solvent used were filtered through a 0.45 μm and 0.1 μm filter prior to addition to aqueous samples. All resuspended lyophilized samples were refiltered through a 0.45 μm filter prior to measurement.

Small-Angle Neutron Scattering. Small-angle neutron scattering (SANS) samples were prepared in deuterated water and ethanol at 20 mg/mL total polymer concentration and 2 mg/mL total OPH concentration.

Lyophilization. All samples were prepared in buffer and frozen in liquid nitrogen prior to being placed on the lyophilizer.

Activity Assays. The specific activity of aqueous solutions was measured by assaying against methyl paraoxon. Paraoxon degradation was monitored via tracking the formation of the degradation product, p-Nitrophenol. In these assays, p-Nitrophenol concentration was monitored by measuring absorbance at 405 nm. Serial dilutions of OPH solutions were assayed in triplicate in a Tecan plate reader over 5 minutes, and the dilution that resulted in a linear absorbance versus time curve was used to calculate specific activity. Specific activity was calculated using the following equation:

$$Specific Activity ( \frac{µmol}{min \times mg} ) = \frac{Slope \times {10}^{6} \times Dilution Factor}{1000 \times 17100 \times 1.0 \times C}$$

where the dilution factor refers to the amount of dilution performed on the OPH solution, C is the concentration of OPH in the original solution (mg/L), 1.0 is the path length of the light (cm), and 17100 is the molar extinction coefficient ofp-nitrophenol (M⁻¹ cm⁻¹).

The specific activity of organic solvent solutions was measured by assaying against methyl paraoxon. Solutions of 4 mg/mL total polymer and ˜0.5 mg/mL OPH were incubated in 96 vol % of each organic solvent and 4 vol % 50 mM pH 8 HEPES buffer with 100 μM CoCl₂ for 24 hours prior to assaying the activity. Assays themselves were performed by diluting the incubated solutions 10 fold into 50 mM pH 8 HEPES buffer with 100 μM CoCl₂ containing methyl paraoxon. The activity was then tracked by monitoring absorbance at 340 nm for ethanol and 345 nm for DMMP. These absorbances were converted to p-nitrophenol concentrations using a calibration curve prepared with p-nitrophenol in solutions made up of the same amount of buffer and organic solvent as the assay.

### INCORPORATION BY REFERENCE

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicants reserve the right to physically incorporate into this application any and all materials and information from any such articles, patents, patent applications, or other physical and electronic documents.

### EQUIVALENTS

The invention has been described broadly and generically herein. Those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention. Further, each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

We claim:

1. A nanostructure comprising:
a polyanionic polymer;
a block copolymer; and
an enzyme; or
(ii) a block copolymer; and
a modified enzyme.

2. The nanostructure of claim 1, wherein the block copolymer comprises a plurality of first repeat units, and a plurality of second repeat units;
the first repeat unit is 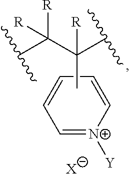
wherein, independently for each occurrence,
R is H, alkyl, halo, hydroxy, amino, nitro, or cyano;
Y is alkyl; and
X⊖ is an anion; and
the second repeat unit is 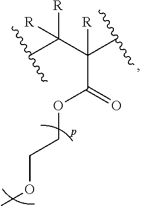
wherein, independently for each occurrence,
R is H, alkyl, halo, hydroxy, amino, nitro, or cyano; and
p is 2-20, inclusive.

3. The nanostructure of claim 2, wherein the molecular weight of the 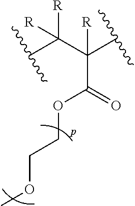
block is about 12 kDa to about 60 kDa.

4. The nanostructure of claim 2, wherein the molecular weight of the 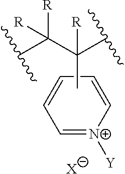
block is about 5 kDa to about 30 kDa.

5. The nanostructure of claim 1, wherein the block copolymer has the following structure: 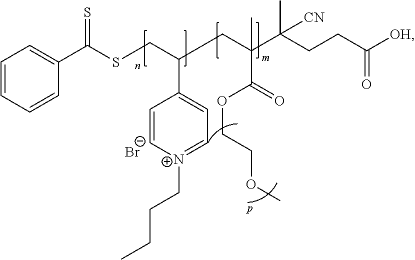
wherein n is 50 to 150, inclusive; and m is 60 to 200, inclusive.

6. The nanostructure of claim 1, wherein the enzyme or modified enzyme is an organophosphate hydrolase or a modified organophosphate hydrolase.

7. The nanostructure of claim 1, wherein the enzyme or modified enzyme is an organophosphate acid anhydrolase or a modified organophosphate acid anhydrolase.

8. The nanostructure of claim 1, wherein the nanostructure is a nanostructure of form (i);
and the polyanionic polymer is polyacrylic acid.

9. The nanostructure of claim 1, wherein the nanostructure is a nanostructure of form (ii);
and the modified enzyme comprises at least one non-natural pendant anionic moiety.

10. The nanostructure of claim 9, wherein the pendant anionic moiety is covalently bonded to a lysine residue.

11. The nanostructure of claim 9, wherein the pendant anionic moiety is a carboxylate moiety.

12. The nanostructure of claim 1, wherein the nanostructure further comprises an aqueous liquid.

13. The nanostructure of claim 12, wherein the aqueous liquid comprises a buffer.

14. The nanostructure of claim 13, wherein the concentration of buffer in the aqueous liquid is about 10 mM to about 100 mM.

15. The nanostructure of claim 12, wherein the pH of the aqueous liquid is about 6.5, about 7.0, about 7.5, about 8.0, about 8.5, about 9.0, or about 9.5.

16. A composition comprising:
an organic phase, an aqueous liquid phase, and a plurality of nanostructures of claim 1.

17. The composition of claim 16, wherein the organic phase comprises, consists essentially of, or consists of ethanol.

18. The composition of claim 16, wherein the organic phase comprises, consists essentially of, or consists of DMMP.

19. The composition of claim 16, wherein the total concentration of block copolymer and polyanionic polymer in the composition is about 1 mg/mL to about 40 mg/mL.

20. The composition of claim 16, wherein the concentration of block copolymer in the composition is about 1 mg/mL to about 40 mg/mL.

21. The composition of claim 16, wherein the concentration of enzyme or modified enzyme in the composition is about 1 mg/mL to about 40 mg/mL.

22. The composition of claim 16, wherein the volume ratio of organic phase to aqueous liquid phase is about 99:1 to about 90:10.

23. A method of hydrolyzing an organophosphorous compound, comprising contacting the organophosphorous compound with an effective amount of a nanostructure of claim 1.

24. The method of claim 23, wherein the organophosphorus compound is selected from the group consisting of: GA, GB, GD, GF, VE, VG, VM, VR, and VX.

25. A method of decontaminating an area or a device contaminated with an organophosphorous compound, comprising contacting the area or the device with an effective amount of a nanostructure of claim 1.

26. The method of claim 25, wherein the organophosphorus compound is selected from the group consisting of: GA, GB, GD, GF, VE, VG, VM, VR, and VX.
